(19) United States
(12) Patent Application Publication
(10) Pub. No.: US 2011/0134076 A1
(43) Pub. Date: Jun. 9, 2011

(54) CAPACITIVE TOUCH PANEL AND DISPLAY DEVICE WITH TOUCH DETECTION FUNCTION

(75) Inventors: Yoshitoshi Kida, Aichi (JP); Koji Ishizaki, Aichi (JP); Kouji Noguchi, Kanagawa (JP); Takeya Takeuchi, Aichi (JP); Tsutomu Harada, Aichi (JP); Takayuki Nakanishi, Aichi (JP)

(73) Assignee: SONY CORPORATION, Tokyo (JP)

(21) Appl. No.: 13/059,044

(22) PCT Filed: Jun. 14, 2010
(86) PCT No.: PCT/JP2010/060055

§ 371 Date: Feb. 14, 2011

(30) Foreign Application Priority Data
Jun. 29, 2009 (JP) 2009-154208

(51) Int. Cl. G06F 3/044

(52) U.S. Cl. 345/174

(57) ABSTRACT

A capacitive touch panel capable of reducing a disturbance noise and reducing touch detection time with a simple structure is obtained. The capacitive touch panel includes: a plurality of drive electrodes each to which a drive signal for touch detection is applied; a plurality of touch detection electrodes arranged to intersect the plurality of drive electrodes, and each outputting a detection signal synchronized with the drive signal; a first sampling circuit (A/D conversion circuits 72 and 73) extracting a first series of sampling signal including a signal component with first level and a noise component, from the detection signal; a second sampling circuit (A/D conversion circuits 75 and 76) extracting a second series of sampling signal including a signal component with second level different from the first level and the noise component, from the detection signal; a filter circuit (digital LPFs 81 and 82) performing a high range cut process on the first series of sampling signal and the second series of sampling signal; and a computation circuit (a subtraction circuit 90) determining a signal for touch detection based on an output of the filter circuit.

### TECHNICAL FIELD

The present invention relates to a touch panel capable of information input by contact or proximity of a user's finger or the like, in particular, to a capacitive touch panel detecting a touch based on a change of an electrostatic capacitance, and a display device with an electrostatic capacitance type touch detection function.

### BACKGROUND ART

In recent years, a display device capable of information input by mounting a contact detection device, which is a so-called touch panel, on a display device such as a liquid crystal display device, and displaying various button images on the display device instead of typical mechanical buttons has attracted attention. There are several methods of the touch panel, such as an optical method and a resistance method, and a capacitive touch panel capable of realizing low consumption power while having a relatively-simple structure has been expected, in particular, in a portable terminal or the like. However, in the capacitive touch panel, a human body functions as an antenna to a noise (hereinafter, referred to as a disturbance-noise) due to an inverter fluorescent lamp, an AM wave, an AC power source, or the like, and there is a possibility that malfunction is caused by propagation of the noise to the touch panel.

This malfunction is caused by that a signal (hereinafter, referred to as a touch signal) related to presence or absence of a touch generated by a user's finger or the like in contact with or in proximity to the touch panel, and the disturbance-noise are not distinguishable. Thus, for example, in Patent Document 1, when the touch signal synchronized with a signal (hereinafter, a drive signal) driving the capacitive touch panel is detected, a detection method in which conditions not influenced by the disturbance-noise are selected by using a plurality of drive signals at different frequencies has been proposed.

### CITATION LIST

### Patent Document

Patent Document 1: U.S. Patent Publication No. 2007/0257890

### SUMMARY OF THE INVENTION

However, in the drive method and the detection method of the capacitive touch panel disclosed in Patent Document 1 described above, since it is necessary to sequentially switch frequencies of the drive signals to select the conditions not influenced by the disturbance-noise, there is a possibility that it takes time for selecting the conditions. In other words, there is a possibility that detection time is long. Further, since the drive signals at the plurality of frequencies are prepared, and determination for switching those frequencies or the like is necessary, there is a possibility that the circuit structure is complicated and large.

In view of the foregoing issues, it is an object of the present invention to provide a capacitive touch panel capable of reducing influence of a disturbance-noise with a relatively-simple circuit structure, and reducing time necessary for touch detection, and a display device with a touch detection function.

A capacitive touch panel according to an embodiment of the present invention includes: a plurality of drive electrodes; a plurality of touch detection electrodes; a first sampling circuit and a second sampling circuit; a filter circuit; and a computation circuit. Here, the plurality of drive electrodes and the plurality of touch detection electrodes are arranged to intersect each other so that an electrostatic capacitance is formed at each of intersections, and a detection signal synchronized with a drive signal applied to each drive electrode is output from each touch detection electrode. The first sampling circuit extracts a first series of sampling signal from the detection signal output from each of the touch detection electrodes, the first series of sampling signal including a signal component with first level and including a noise component, and the second sampling circuit extracts a second series of sampling signal from the detection signal output from each of the touch detection electrodes, the second series of sampling signal including a signal component with second level different from the first level and the including a noise component. The filter circuit is a low pass filter performing a high range cut process which allows a band higher than or equal to a predetermined frequency to be cut from the first and second series of sampling signals. The computation circuit determines a signal for touch detection based on an output of the filter circuit.

A display device with a touch detection function according to an embodiment of the present invention includes: the capacitive touch panel according to the embodiment of the present invention. In this case, the drive signal for touch detection is configured to also serve as a part of a display drive signal.

In the capacitive touch panel and the display device with the touch detection function according to the embodiments of the present invention, a polarity-alternating signal with an amplitude waveform according to an electrostatic capacitance between the drive electrode and the touch detection electrode is output as the detection signal from the touch detection electrode in synchronization with the drive signal applied to the drive electrode. At this time, if there is an external adjacent object such as a finger, the electrostatic capacitance between the drive electrode and the touch detection electrode, in a portion corresponding to this object, is changed, and that change (touch component) appears in the detection signal. At that time, a disturbance-noise is also propagated to the touch panel through a human body, and the noise component appears in the touch detection electrode and is superimposed on the detection signal. This detection signal is sampled in each of the first sampling circuit and the second sampling circuit, and the first series of sampling signal and the second series of sampling signal are determined. In these sampling signals, a frequency band is limited to be in a low range by the filter circuit, and the noise component included in the frequency band is reduced. It is possible to determine the signal for touch detection by performing a predetermined calculation in the computation circuit by using the output of the filter circuit. The signal for touch detection is used for detecting presence or absence, and a position of the external adjacent object.

In the capacitive touch panel according to the embodiment of the present invention, it is possible to determine the signal for touch detection by calculating a difference between the first series of sampling signal and the second series of sampling signal. In this case, one or both of a phase of the first series of sampling signal and a phase of the second series of sampling signal are adjusted to coincide both the phases to each other, the first series of sampling signal and the second series of sampling signal being processed by the filter circuit, and a difference between the two sampling signals is preferably determined.

As the drive signal, it is possible to use a signal with a periodic waveform including a section of a first voltage and a section of a second voltage different from the first voltage. In this case, a sampling period in the first sampling circuit is equal to a sampling period in the second sampling circuit, and a sampling timing in the first sampling circuit is preferably shifted from a sampling timing in the second sampling circuit by half period. This is able to be realized by slightly shifting a duty ratio of the drive signal from 50%. As a specific example of a sampling method in this case, for example, there is a method that the detection signal is sampled by the first sampling circuit, at a plurality of timings which are located before and after one of voltage change points in the drive signal and are adjacent to one another, and the detection signal is sampled by the second sampling circuit, in a plurality of timings adjacent to each other immediately before an other voltage change point in the drive signal. At this time, the first series of sampling signal from the first sampling circuit includes the signal component with first level and the noise component. Meanwhile, the second series of sampling signal includes only the noise component, and the second level of the signal component is zero level. Therefore, by calculating the difference between the both, the noise component is canceled, and the signal component with first level is extracted.

As another specific example of the sampling method, for example, there is a method as will be described next. A signal with a periodic waveform including a section of a first polarity-alternating waveform with a first amplitude, and a section of a second polarity-alternating waveform with a second amplitude different from the first amplitude is used as the drive signal, the detection signal is sampled by the first sampling circuit, at a plurality of timings which are located before and after a polarity inversion point in the first polarity-alternating waveform and are adjacent to one another, and the detection signal is sampled by the second sampling circuit, at a plurality of timings which are located before and after a polarity inversion point in the second polarity-alternating waveform and are adjacent to one another. In this case, by calculating the difference between the first series of sampling signal and the second series of sampling signal, the noise component is canceled, and only the difference between the signal component with first level and the signal component with second level is extracted.

Also, the sampling method as will be described below may be used. A signal with a periodic waveform including a section of the first polarity-alternating waveform, and a section of the second polarity-alternating waveform, the first polarity-alternating waveform and the second polarity-alternating waveform having phases shifted from each other, is used as the drive signal, the detection signal is sampled by the first sampling circuit, at a plurality of timings which are located before and after one of voltage change points in the first polarity-alternating waveform and are adjacent to one another, and the detection signal is sampled by the second sampling circuit, at a plurality of timings which are located immediately before one of voltage change points in the second polarity-alternating waveform and are adjacent to one other. In this case, by calculating the difference between the first series of sampling signal and the second series of sampling signal, the noise component is canceled, and only the difference between the signal component with fist level and the signal component with second level is extracted.

According to the capacitive touch panel and the display device with the touch detection function according to the embodiment of the present invention, when a contact position or an adjacent position by the object is detected based on the detection signal determined by the touch detection electrode according to a change of the electrostatic capacitance, the first series of sampling signal including the signal component with first level and the noise component, and the second series of sampling signal including the signal component with second level different from the first level and the noise component are extracted, and the touch detection is performed based on these sampling signals. Thus, the circuit structure is simplified, and it is possible to shorten the time necessary for the touch detection. Further, the filter circuit is introduced in the subsequent stage of the sampling circuit, so the computation circuit in the subsequent stage of the filter circuit is simplified more, and it is possible to reliably perform the touch detection with a smaller circuit structure.

### BRIEF DESCRIPTION OF DRAWINGS

FIG. 1 is a view for explaining a basic principle of a touch detection method in a capacitive touch panel according to the present invention, and a view illustrating the state where a finger is in contact with or in proximity to the touch panel.

FIG. 2 is a view for explaining the basic principle of the touch detection method in the capacitive touch panel according to the present invention, and a view illustrating the state where the finger is not in contact with or not in proximity to the touch panel.

FIG. 3 is a view for explaining the basic principle of the touch detection method in the capacitive touch panel according to the present invention, and a view illustrating an example of waveforms of a drive signal and a detection signal.

FIG. 4 is a block diagram illustrating a structural example of the capacitive touch panel according to a first embodiment of the present invention.

FIG. 5 is a perspective view illustrating a structural example of a touch sensor illustrated in FIG. 4.

FIG. 6 is a timing diagram illustrating waveforms of the drive signal and the detection signal illustrated in FIG. 4, and a sampling timing.

FIG. 7 is a block diagram illustrating a structural example of an A/D conversion section, and a signal process section illustrated in FIG. 4.

FIG. 8 is a block diagram illustrating a structural example of a phase difference detection circuit illustrated in FIG. 7.

FIG. 9 is a view illustrating an example of a timing in the state where there is no disturbance-noise in the capacitive touch panel illustrated in FIG. 4.

FIG. 10 is a view illustrating an example of a spectrum for explaining reduction of the disturbance-noise by a digital LPF illustrated in FIG. 7.

FIG. 11 is a view illustrating an example of a timing in the state where there is a disturbance-noise at a frequency close to three times a sampling frequency in the capacitive touch panel illustrated in FIG. 4.

FIG. 12 is a view illustrating an example of a timing in the state where there is the disturbance-noise at a frequency close to twice the sampling frequency in the capacitive touch panel illustrating in FIG. 4.

FIG. 13 is a view illustrating an example of a timing in the state where there are a touch component and a disturbance-noise in the capacitive touch panel illustrated in FIG. 4.

FIG. 14 is a view illustrating an operational example of the capacitive touch panel illustrated in FIG. 4.

FIG. 15 is a block diagram illustrating a structural example of the capacitive touch panel according to a second embodiment of the present invention.

FIG. 16 is a timing chart example illustrating an operational timing in the A/D conversion section illustrated in FIG. 15.

FIG. 17 is a view illustrating an example of a timing in the state where there are the touch component and the disturbance-noise in the capacitive touch panel illustrated in FIG. 15.

FIG. 18 is a timing diagram illustrating the operational example in the A/D conversion section according to a modification of the second embodiment of the present invention.

FIG. 19 is a view illustrating an example of a timing in the state where there are the touch component and the disturbance noise in the capacitive touch panel according to the modification of the second embodiment of the present invention.

FIG. 20 is a block diagram illustrating a structural example of a display device with a touch detection function according to a third embodiment of the present invention.

FIG. 21 is a cross-sectional view illustrating a schematic cross-sectional structure of a display section illustrated in FIG. 20.

FIG. 22 is a structural example illustrating a pixel structure of a liquid crystal display device illustrated in FIG. 21.

FIG. 23 is a cross-sectional view illustrating a schematic cross-sectional structure of the display section according to a modification of the third embodiment.

FIG. 24 is a timing diagram illustrating waveforms of the drive signal and the detection signal, and a sampling timing according to a modification of the first embodiment.

FIG. 25 illustrates an appearance structure of an application example 1 in the display device with the electrostatic capacitance type touch detection function to which each of the embodiments is applied, (A) is an appearance view as viewed from a front side, and (B) is a perspective view illustrating an appearance as viewed from a rear side.

FIG. 26 illustrates an appearance structure of an application example 2, (A) is a perspective view illustrating an appearance as viewed from the front side, and (B) is a perspective view illustrating an appearance as viewed from the rear side.

FIG. 27 is a perspective view illustrating an appearance structure of an application example 3.

FIG. 28 is a perspective view illustrating an appearance structure of an application example 4.

FIG. 29 illustrates an appearance structure of an application example 5, (A) illustrates a front view in a unclosed state, (B) illustrates a side view thereof, (C) is a front view in a closed state, (D) is a left side view thereof, (E) is a right side view thereof, (F) is a top face view thereof, and (G) is a bottom face view thereof.

### DESCRIPTION OF EMBODIMENTS

A description will be hereinafter given in detail of an embodiment of the invention with reference to the drawings. In addition, the description will be given in the following order.

1. Basic principle of electrostatic capacitance type touch detection
2. First embodiment
3. Second embodiment
4. Third embodiment
5. Application examples

### 1. Basic Principle of Electrostatic Capacitance Type Touch Detection

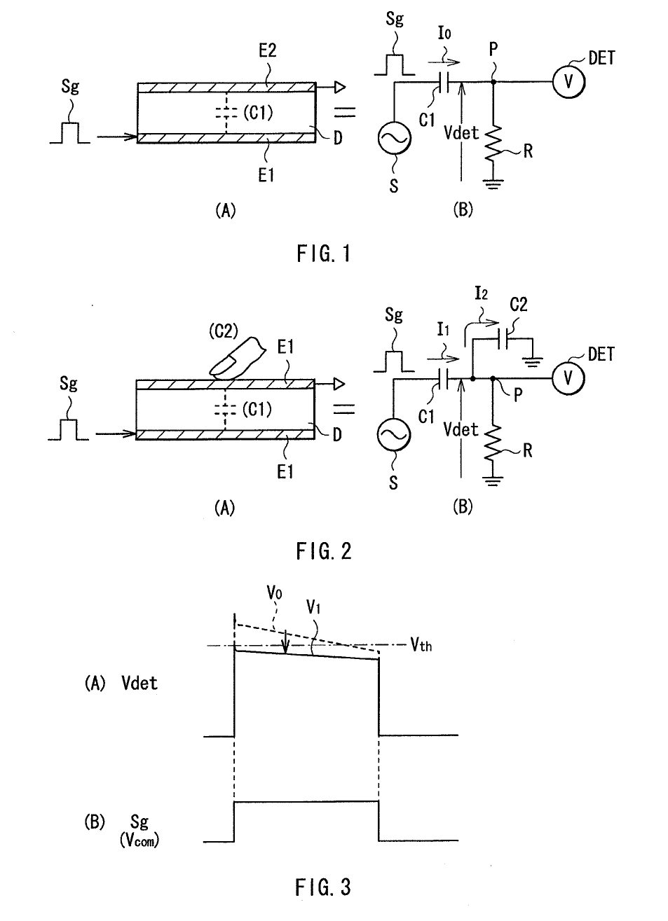

First, with reference to FIGS. 1 to 3, a basic principle of a touch detection method in a capacitive touch panel of the present invention will be described. For example, as illustrated in FIG. 1(A), in this touch detection method, a capacitance element is constituted by using a pair of electrodes (a drive electrode E1 and a detection electrode E2) arranged to face each other with a dielectric body D in between. This structure is expressed as an equivalent circuit illustrated in FIG. 1(B). A capacitance element C1 is constituted of the drive electrode E1, the detection electrode E2, and the dielectric body D. In the capacitance element C1, one end is connected to an alternating signal source (drive signal source) S, and another end P is grounded through a resister R, and connected to a voltage detector (detection circuit) DET. When an alternating rectangular wave Sg (FIG. 3(B)) at a predetermined frequency (for example, several kHz to several tens of kHz) is applied from the alternating signal source S to the drive electrode E1 (one end of the capacitance element C1), an output waveform (a detection signal Vdet) as illustrated in FIG. 3(A) appears in the detection electrode E2 (the other end P of the capacitance element C1). In addition, this alternating rectangular wave Sg corresponds to a drive signal Vcom, which will be described later.

In the state where a finger is not in contact with (or not in proximity to) the touch panel, as illustrated in FIG. 1, a current I0 corresponding to a capacitance value of the capacitance element C1 flows with charge/discharge to the capacitance element C1. A potential waveform of the other end P of the capacitance element C1 at this time is, for example, like a waveform V0 of FIG. 3(A), and this is detected by the voltage detector DET.

Meanwhile, in the state where the finger is in contact with (or in proximity to) the touch panel, as illustrated in FIG. 2, a capacitance element C2 formed by the finger is added in series to the capacitance element C1. In this state, currents I1 and I2 flow with charge/discharge to the capacitance elements C1 and C2, respectively. The potential waveform of the other end P of the capacitance element C1 at this time is, for example, like a waveform V1 of FIG. 3(A), and this is detected by the voltage detector DET. The potential of a point P at this time is a partial-voltage potential defined by values of the currents I1 and I2 flowing through the capacitance elements C1 and C2. Thus, the waveform V1 has a value smaller than that of the waveform V0 in a non-contact state. The voltage detector DET compares the detected voltage with a predetermined threshold voltage Vth, and determines that it is in the non-contact state when the detected voltage is equal to or larger than this threshold voltage. Meanwhile, the voltage detector DET determines that it is in a contact state when the detected voltage is smaller than the threshold voltage. In this manner, the touch detection is possible.

### 2. First Embodiment

### Structural Example

### Overall Structural Example

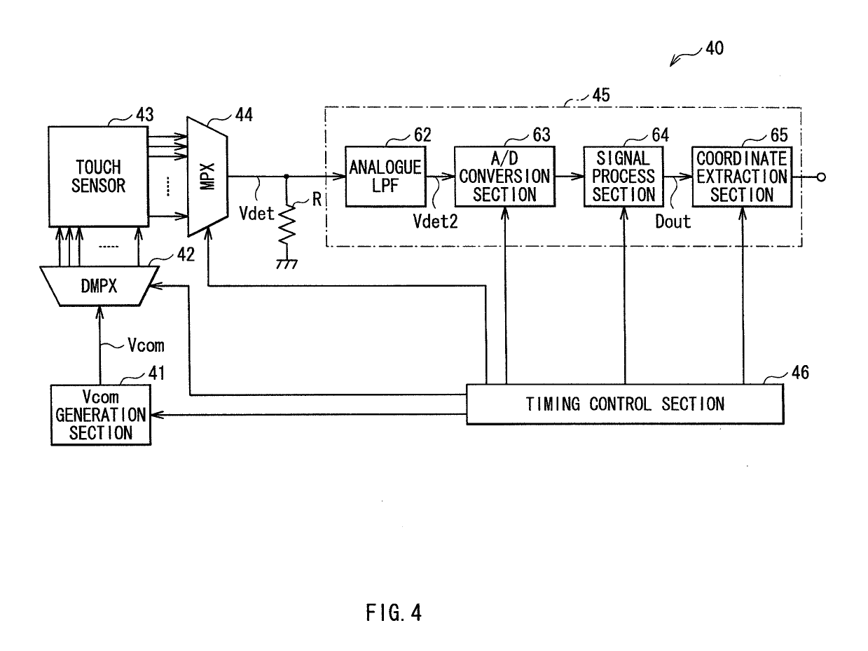

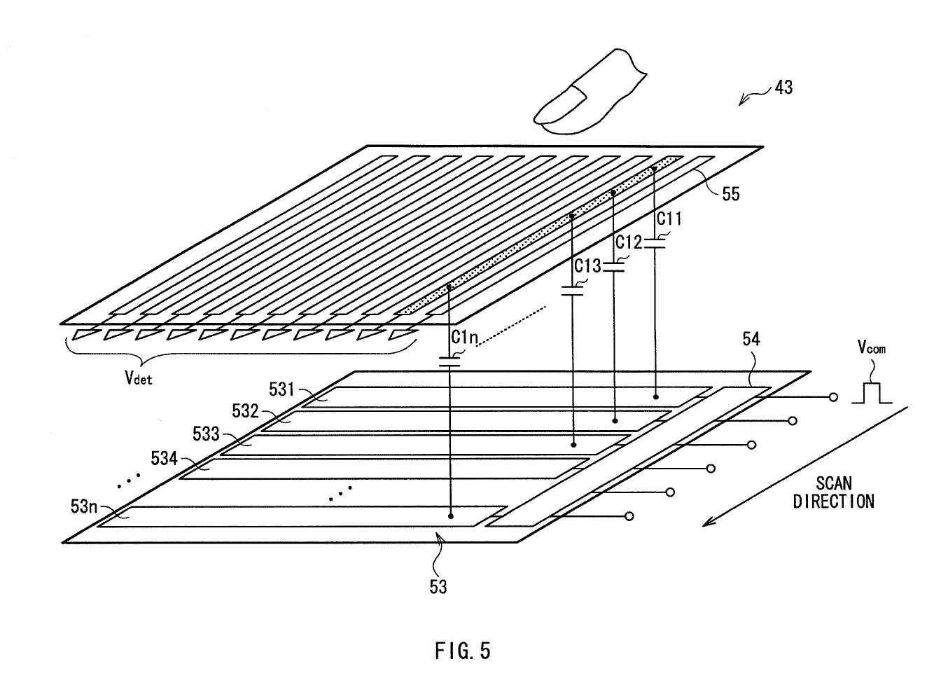

FIG. 4 illustrates a structural example of a capacitive touch panel 40 according to a first embodiment of the present invention. The capacitive touch panel 40 includes a Vcom generation section 41, a demultiplexer 42, a touch sensor 43, a multiplexer 44, a detecting section 45, a timing control section 46, and a resistance R.

The Vcom generation section 41 is a circuit generating the drive signal Vcom driving the touch sensor 43. Here, in the drive signal Vcom, its duty ratio is slightly shifted from 50%, as will be described later.

When the drive signal Vcom supplied from the Vcom generation section 41 is supplied to a plurality of drive electrodes of the touch sensor 43 one after another, which will be described later, the demultiplexer 42 is a circuit switching its supply destination.

The touch sensor 43 is a sensor detecting a touch based on the basic principle of the electrostatic capacitance type touch detection described above.

FIG. 5 illustrates a structural example of the touch sensor 43 in a perspective state. The touch sensor 43 includes a plurality of drive electrodes 53, a drive electrode driver 54 driving the drive electrodes 53, and a touch detection electrode 55.

The drive electrode 53 is divided into a plurality of stripe-shaped electrode patterns (here, they are constituted of a number n (n: an integer of 2 or larger) of drive electrodes 531 to 53n as an example) extending in a right and left direction of the figure. The drive signal Vcom is supplied to each electrode pattern one after another by the drive electrode driver 54, and a line-sequential scanning drive is time-divisionally performed. Meanwhile, the touch detection electrode 55 is constituted of a plurality of stripe-shaped electrode patterns extending in a direction orthogonal to the extending direction of the electrode patterns of the drive electrode 53. The electrode patterns intersecting each other by the drive electrode 53 and the touch detection electrode 55 form an electrostatic capacitance in its intersecting portion. In FIG. 5, electrostatic capacitances C11 to C1n formed between an electrode focused by the touch detection electrode 55, and each of the drive electrodes 531 to 53n are illustrated as an example of the electrostatic capacitance.

The drive electrode 53 corresponds to the drive electrode E1 illustrated in FIGS. 1 and 2 as the basic principle of the electrostatic capacitance type touch detection. Meanwhile, the touch detection electrode 55 corresponds to the detection electrode E2 illustrated in FIGS. 1 and 2. Thereby, the touch sensor 43 is able to detect a touch by following the basic principle of the electrostatic capacitance type touch detection described above. Further, the electrode patterns intersecting each other as described above constitute the touch sensors in matrix. Therefore, detection of a touched position is possible.

When a detection signal output from the touch sensor 43 is sequentially extracted from the plurality of touch detection electrodes 55, the multiplexer 44 is a circuit switching its extraction source.

The detecting section 45 is a circuit detecting whether or not the finger or the like is in contact with or in proximity to the touch sensor 43 based on the detection signal switched by the multiplexer 44, and, further, detecting a coordinate when the finger or the like is in contact with or in proximity to the touch sensor 43. The detection section 45 includes an analogue LPF (Low Pass Filter) 62, an A/D conversion section 63, a signal process section 64, and a coordinate extraction section 65.

The analogue LPF 62 is a low pass filter removing a high frequency component in the detection signal Vdet and outputting the resultant signal as a detection signal Vdet2. The A/D conversion section 63 is a circuit converting the detection signal Vdet2 into a digital signal, and the signal process section 64 is a logic circuit determining presence or absence of a touch based on the output signal of the A/D conversion section 63. In addition, detail of the A/D conversion section 63 and the signal process section 64 will be described later. The coordinate extraction section 65 is a logic circuit detecting a touch panel coordinate on which the touch detection has been performed in the signal process section 64.

The timing control section 46 is a circuit controlling operation timings of the Vcom generation section 41, the demultiplexer 42, the multiplexer 44, and the detecting section 45.

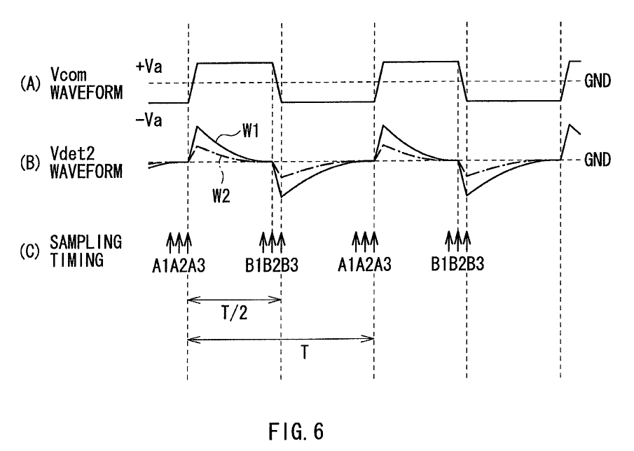

FIG. 6 illustrates a waveform (A) of the drive signal Vcom and a waveform (B) of the detection signal Vdet2, and a sampling timing (C) in the A/D conversion section 63.

The waveform of the drive signal Vcom is a rectangular wave with a period T in which polarities are alternated (polarities are alternately inverted), and includes a section of a first voltage (+Va) and a section of a second voltage (−Va). Its duty ratio is slightly shifted from 50% as described above. The waveform of the detection signal Vdet2 is a waveform synchronized with the drive signal Vcom, and has an amplitude according to the electrostatic capacitance between the drive electrode 53 and the touch detection electrode 55. In other words, the detection signal Vdet2 has a waveform W1 with a large amplitude in the state where the finger or the like is not in contact with or not in proximity to the touch sensor. Meanwhile, the detection signal Vdet2 has a waveform W2 with a small amplitude in the state where the finger or the like is in contact with or in proximity to the touch sensor.

Six sampling timings A1, A2, A3, B1, B2, and B3 illustrated in FIG. 6(C) are synchronized with the drive signal Vcom, and respective sampling frequencies fs are the same as an inverse of the period T of the drive signal Vcom.

These sampling timings (hereinafter, simply referred to as “timings” according to needs) exist three by three, adjacent to each other in the vicinity of a rise and in the vicinity of a fall of the drive signal Vcom. The three sampling timings A1, A2, and A3 are set in time order in the vicinity of the rise of the drive signal Vcom. Meanwhile, the three sampling timings B1, B2, and B3 are set in time order in the vicinity of the fall of the drive signal Vcom.

The time difference between the sampling timings corresponding to the vicinity of the rise and the vicinity of the fall, respectively, is half period T of the drive signal Vcom. In other words, the time difference between the sampling timings A1 and B1, the time difference between the sampling timings A2 and B2, and the time difference between the sampling timings A3 and C3 are T/2, respectively.

All the three sampling timings A1 to A3 in the vicinity of the rise of the drive signal Vcom are positioned immediately before the rise of the drive signal Vcom. Meanwhile, in the three sampling timings in the vicinity of the fall of the drive signal Vcom, B1 and B2 exist immediately before the fall, and B3 is positioned immediately after the fall.

In addition, the duty ratio of the drive signal Vcom is slightly shifted from 50% as described above so that the sampling timings A1, A2, A3, B1, B2, and B3 satisfy the above-described relation.

(Circuit Structural Example of A/D Conversion Section and Signal Process Section)

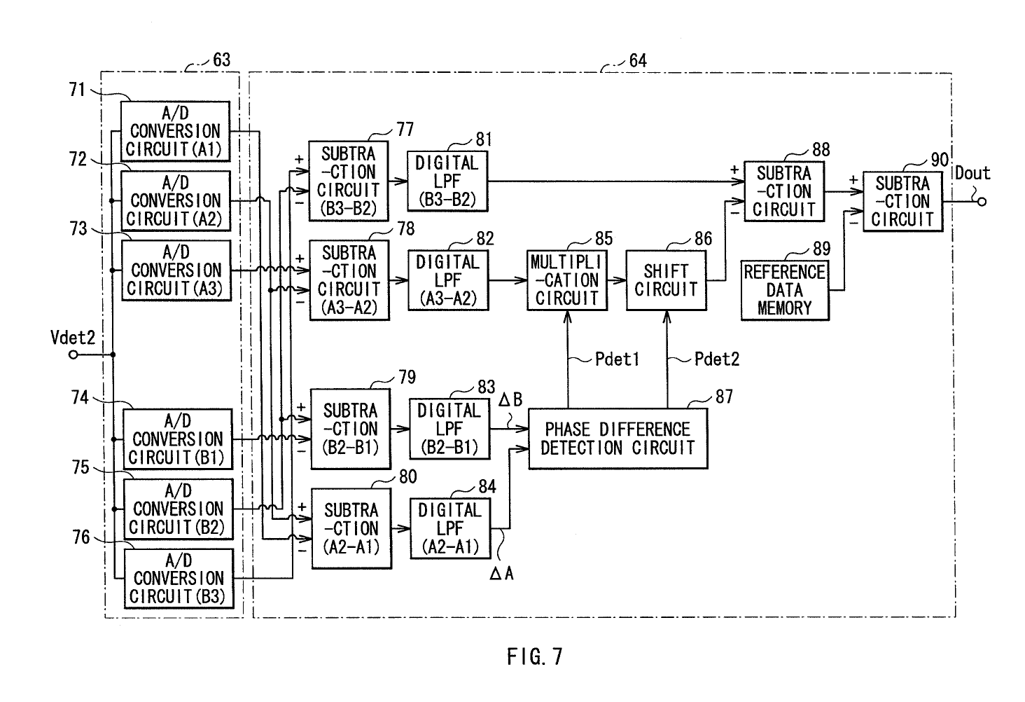

FIG. 7 illustrates a circuit structural example of the A/D conversion section 63 and the signal process section 64.

The A/D conversion section 63 is a circuit sampling and digitalizing the detection signal Vdet2, and includes A/D conversion circuits 71 to 76 sampling the detection signal Vdet2 in the above-described six sampling timings (A1, A2, A3, B1, B2, and B3), respectively.

As illustrated in FIG. 7, the signal process section 64 includes subtraction circuits 77 to 80, 88, and 90, digital LPFs (Low Pass Filters) 81 to 84, a multiplication circuit 85, a shift circuit 86, a phase difference detection circuit 87, and a reference data memory 89.

The subtraction circuits 77 to 80 are logic circuits performing a subtraction by using output signals of the six A/D conversion circuits 71 to 76 of the A/D conversion section 63. Specifically, the subtraction circuit 77 subtracts an output signal of the A/D conversion circuit 75 (the timing B2) from an output signal of the A/D conversion circuit 76 (the timing B3), and the subtraction circuit 78 subtracts an output signal of the A/D conversion circuit 72 (the timing A2) from an output signal of the A/D conversion circuit 73 (the timing A3). The subtraction circuit 79 subtracts an output signal of the A/D conversion circuit 74 (the timing B1) from an output signal of the A/D conversion circuit 75 (the timing B2), and the subtraction circuit 80 subtracts an output signal of the A/D conversion circuit 71 (the timing A1) from an output signal of the A/D conversion circuit 72 (the timing A2).

Here, first, the subtraction circuits 77 and 78 are focused. In FIG. 7, the subtraction circuit 77 subtracts a sampled result of the detection signal Vdet2 in the timing B2 from a sampled result of the detection signal Vdet2 in the timing B3, and detects and outputs a change of the detection signal Vdet2 due to the fall of the drive signal Vcom. Meanwhile, the subtraction circuit 78 subtracts a sampled result of the detection signal Vdet2 in the timing A2 from a sampled result of the detection signal Vdet2 in the timing A3, and does not detect the change of the detection signal Vdet2 due to the rise and the fall of the drive signal Vcom. In other words, although the output of the subtraction circuit 77 includes the change by the touch operation, the output of the subtraction circuit 78 does not include the change by the touch operation. Here, further, the case where the disturbance-noise is included in the detection signal Vdet2 will be considered. In this case, the noise component is included in both the output signals of the subtraction circuits 77 and 78. Therefore, as will be described later, it is possible to remove the disturbance-noise and determine the touch detection signal by calculating the difference between the output signal of the subtraction circuit 77 and the output signal of the subtraction circuit 78.

Next, the subtraction circuits 79 and 80 will be focused. In FIG. 7, the subtraction circuit 79 subtracts a sampled result of the detection signal Vdet2 in the timing B1 from a sampled result of the detection signal Vdet2 in the timing B2, and does not detect the change of the detection signal Vdet2 due to the rise and the fall of the drive signal Vcom. In the same manner, the subtraction circuit 80 subtracts a sampled result of the detection signal Vdet2 in the sampling timing A1 from a sampled result of the detection signal Vdet2 in the timing A2, and does not detect the change of the detection signal Vdet2 due to the rise and the fall of the drive signal Vcom. Therefore, the outputs of the subtraction circuits 79 and 80 do not include the change by the touch operation. Here, the case where the disturbance-noise is included in the detection signal Vdet2 will be considered. In this case, the noise component is included in both the output signals of the subtraction circuits 79 and 80. As will be described later, the subtraction circuits 79 and 80 detect only a change amount of the disturbance-noise without being influenced by the touch operation.

The digital LPF 81 to 84 are logic circuits performing a calculation of the low-pass filter by using time-series data of the output signals from the subtraction circuits 77 to 80. Specifically, the digital LPF 81 performs calculation by using the time-series data of the output signal from the subtraction circuit 77, and the digital LPF 82 performs calculation by using the time-series data of the output signal from the subtraction circuit 78. Also, the digital LPF 83 performs calculation by using the time-series data of the output signal from the subtraction circuit 79, and outputs the calculation result as a noise change amount detection signal ΔB, and the digital LPF 84 performs calculation by using the time-series data of the output signal from the subtraction circuit 80, and outputs the calculation result as a noise change amount detection signal ΔA.

The multiplication circuit 85 is a logic circuit multiplying the output signal of the digital LPF 82 and a phase difference detection signal Pdet1 as being an output signal of the phase difference detection circuit 87, which will be described later. Further, the shift circuit 86 is a logic circuit shifting the time-series data of the output signal from the multiplication circuit 85 in a time axis direction based on a phase difference detection signal Pdet2 as being an output signal of the phase difference detection circuit 87, which will be described later.

The phase difference detection circuit 87 is a logic circuit receiving the noise change detection signals ΔA and ΔB, detecting the phase difference between the time-series data of these two signals, and outputting the results as the phase difference detection signals Pdet1 and Pdet2.

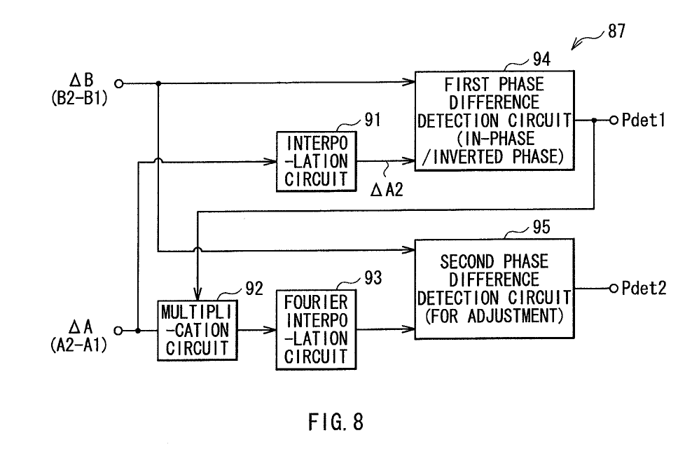

FIG. 8 illustrates a circuit structural example of the phase difference detection circuit 87. The phase difference detection circuit 87 includes an interpolation circuit 91, a multiplication circuit 92, a Fourier interpolation circuit 93, a first phase difference detection circuit 94, and a second phase difference detection circuit 95.

The interpolation circuit 91 is a logic circuit performing an interpolation process on the time-series data of the noise change amount detection signal ΔA. The first phase difference detection circuit 94 is a logic circuit detecting the phase relation between the time-series data of the noise change amount detection signal ΔB and the time-series data of the output signal from the interpolation circuit 91, and detects whether the phase relation is the in-phase relation or the inversed phase relation to output the result as the phase difference detection signal Pdet1.

The multiplication circuit 92 is a logic circuit multiplying the noise change amount detection signal ΔA and the phase difference detection signal Pdet1 as being the output of the first phase difference detection circuit 94. The Fourier interpolation circuit 93 is a logic circuit performing a Fourier interpolation process on the time-series data of the output signal from the multiplication circuit 92. The second phase difference detection circuit 95 is a logic circuit detecting the phase difference between the time-series data of the noise change amount detection signal ΔB and the time-series data of the output signal from the Fourier interpolation circuit 93. The phase difference detectable by the second phase difference detection circuit 95 is more detailed compared with that detectable by the first phase difference detection circuit 94. The second phase difference detection circuit 95 outputs the detection result of the phase difference as the phase difference detection signal Pdet2.

The subtraction circuit 88 is a logic circuit subtracting an output signal of the shift circuit 86 from an output signal of the digital LPF 81. The reference data memory 89 is a memory storing a digital signal, and stores data when the finger or the like is not in contact with or not in proximity to the touch sensor 43. The subtraction circuit 90 is a logic circuit subtracting an output signal of the reference data memory 89 from an output signal of the subtraction circuit 88. The output signal of the subtraction circuit 90 is the output of the signal process section 64, and is supplied to the coordinate extraction section 65.

Here, the A/D conversion circuits 74 to 76 performing samplings in the sampling timings B1 to B3, and the subtraction circuit 77 correspond to a specific example of “first sampling circuit” in the present invention. In other words, the output of the subtraction circuit 77 corresponds to a specific example of a first series of sampling signal including a signal component with first level and a noise component.

Meanwhile, the A/D conversion circuits 71 to 73 performing samplings in the sampling timings A1 to A3, and the subtraction circuit 78 correspond to a specific example of “second sampling circuit” in the present invention. In other words, the output of the subtraction circuit 78 corresponds to a specific example of a second series of sampling signal including a signal component with second level different from the first level and the noise component. However, in this embodiment, the output of the subtraction circuit 78 corresponds to the second series of sampling signal in which the signal component with second level is 0 (zero).

The digital LPF 81 and 82 correspond to a specific example of “filter circuit” in the present invention. A circuit portion constituted of the subtraction circuits 79, 80, 88, and 90, the digital LPF 83 and 84, the multiplication circuit 85, the shift circuit 86, the phase difference detection circuit 87, and the reference data memory 89 corresponds to a specific example of “computation circuit” in the present invention, The output of the “computation circuit” is “a signal for touch detection” in the present invention, and its specific example corresponds to an output Dout of the subtraction circuit 90, which will be described later.

[Operations and Actions]

(Overall Basic Operations)

First, overall operations of a capacitive touch panel 40 of this embodiment will be described.

The Vcom generation section 41 generates the drive signal Vcom, and supplies the drive signal Vcom to the demultiplexer 42. The demultiplexer 42 supplies the drive signal Vcom to the plurality of drive electrodes 531 to 533n of the touch sensor 43 one after another by sequentially switching the supply destination of the drive signal Vcom. The detection signal Vdet with the waveform having the rise and the fall synchronized with the voltage change timing of the drive signal Vcom is output from each touch detection electrode 55 of the touch sensor 43 based on the basic principle of the electrostatic capacitance type touch detection described above. The multiplexer 44 sequentially extracts the detection signal Vdet output from each touch detection electrode 55 of the touch sensor 43 by sequentially switching the extraction source, and transmits the detection signal Vdet to the detection section 45. In the detection section 45, the analogue LPF 62 removes the high frequency component from the detection signal Vdet, and outputs the resultant signal as the detection signal Vdet2. The A/D conversion section 63 converts the detection signal Vdet2 from the analogue LPF 62 into the digital signal. The signal process section 64 determines presence or absence of the touch on the touch sensor 43 by logic calculation based on the output signal of the A/D conversion section 63. The coordinate extraction section 65 detects the touch coordinate on the touch sensor based on the touch determination result by the signal process section 64. In this manner, the touched position is detected in the case where a user touches the touch panel.

Next, more detailed operations will be described.

(Operations when there is No Disturbance-Noise)

First, operations and actions when there is no disturbance-noise will be described.

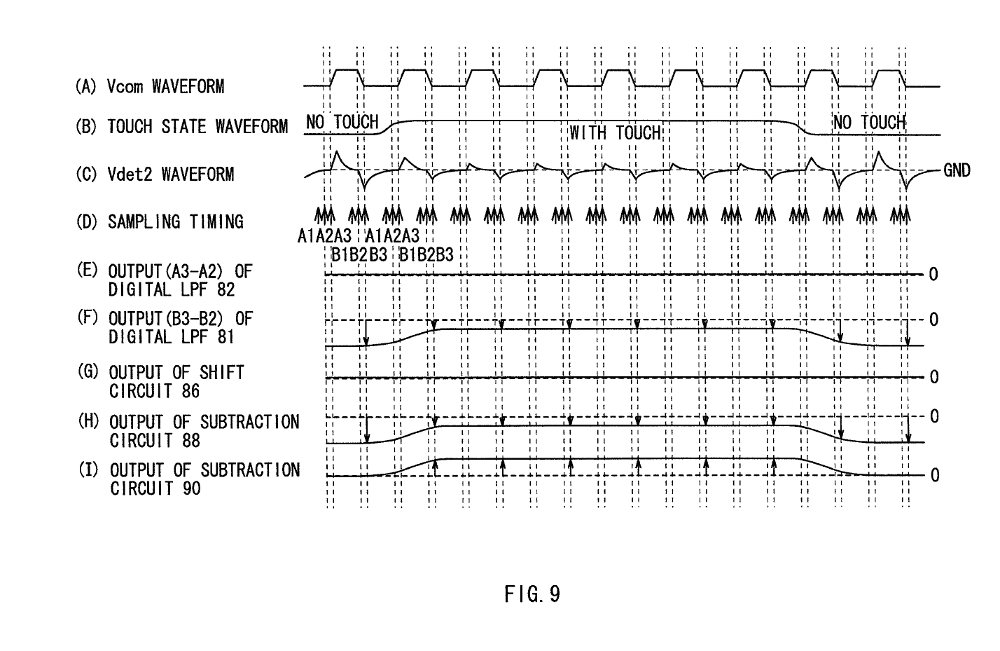

FIG. 9 is a timing chart example of the capacitive touch panel 40 according to the first embodiment of the present invention, and illustrates an example when there is no disturbance-noise.

FIG. 9(A) illustrates a waveform of the drive signal Vcom, (B) illustrates a touch state waveform illustrating presence or absence of the touch operation with the waveform for convenience, and (C) illustrates a waveform of the detection signal Vdet2. Here, in the touch state wave (B), the high level section indicates the state where the finger or the like is in contact with or in proximity to the touch panel, and the low level section indicates the state where the finger or the like is not in contact with or not in proximity to the touch panel. Correspondingly, as illustrated in (C), based on the basic principle of the electrostatic capacitance type touch detection described above, the detection signal Vdet2 has the waveform with the small amplitude when the touch state waveform is at the high level. Meanwhile, the detection signal Vdet2 has the waveform with the large amplitude when the touch state waveform is at the low level.

FIG. 9(D) illustrates the six sampling timings in the A/D conversion section 63, (E) illustrates an output of the digital LPF 82, and (F) illustrates an output of the digital LPF 81. (E) illustrates a waveform in which the sampled result of the detection signal Vdet2 in the timing A2 is subtracted from the sampled result of the detection signal Vdet2 in the timing A3, and thus indicates 0 (zero). Meanwhile, (F) illustrates a waveform in which the sampled result of the detection signal Vdet2 in the timing B2 is subtracted from the sampled result of the detection signal Vdet2 in the timing B3, and the waveform including the change by the touch operation (hereinafter, referred to as “a touch component”) is thus output. This means that this circuit extracts the touch component by using the fall of the drive signal Vcom.

FIG. 9(G) illustrates an output of the shift circuit 86, and (H) illustrates an output of the subtraction circuit 88. In FIG. 7, although the output of the digital LPF 82 is supplied to the multiplication circuit 85, since the output of the digital LPF 82 is 0 (zero) as described above, the output of the multiplication circuit 85 is also 0 (zero). Further, this output is supplied to the shift circuit 86, and the output (G) of the shift circuit 86 is also 0 (zero) in the same manner. Therefore, the output (H) of the subtraction circuit 88 is the same as the output (F) of the digital LPF 81.

FIG. 9(I) illustrates the output Dout of the subtraction circuit 90. In FIG. 7, the output of the subtraction circuit 89 when the finger or the like is not in contact with or not in proximity to the touch panel is stored in the reference data memory 89. The subtraction circuit 90 extracts only the touch component by subtracting the output of the reference data memory 89 from the output of the subtraction circuit 89. In other words, the output Dout (FIG. 9(I)) of the subtraction circuit 90 has the waveform similar to the touch state waveform (FIG. 9(B)).

(Operations when there is a Disturbance-Noise)

Next, operations and actions when there is a disturbance-noise will be described.

In FIG. 7, the digital LPFs 81 to 84 are introduced to reduce influence of a folding noise due to the sampling in the A/D conversion section 63. Typically, when the sampling is performed at the sampling frequency fs, a frequency component equal to or higher than a Nyquist frequency (fs/2) of that input signal appears as a frequency equal to or lower than fs/2 in the output signal (folding noise). The component equal to or higher than the Nyquist frequency of the input signal is typically not necessary. The digital LPFs 81 to 84 have effects narrowing the frequency range in which this unnecessary signal exists.

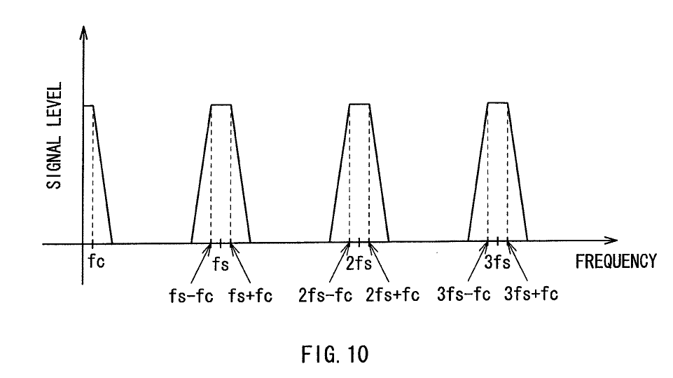

FIG. 10 illustrates that the frequency component in the output signal of the digital LPFs 81 to 84 corresponds to which frequency component in the detection signal Vdet2 as being the input signal of the A/D conversion section 63. The frequency band of the unnecessary signal at a frequency close to integer times the sampling frequency is narrowed by introducing the digital LPFs 81 to 84. The band width is expressed as 2fc by using a cut off frequency fc of the digital LPFs 81 to 84. From this, it is preferable to set the cut off frequency fc low. Meanwhile, it is necessary for the touch component to pass through the digital LPFs 81 to 84. Therefore, the cut off frequency fc is set to approximately the frequency of the touch component.

FIG. 10 signifies that the disturbance-noise having the frequency component close to integer times the sampling frequency of the A/D conversion section 63 passes through the digital LPFs 81 to 84. The present invention also has a mechanism to prevent malfunction caused by this.

Hereinafter, the case where the disturbance-noise has a frequency close to odd number times the sampling frequency, and the case where the disturbance-noise has a frequency close to even number times the sampling frequency will be separately described in detail.

(I) Case where there is a Disturbance-Noise at a Frequency Close to Odd Number Times the Sampling Frequency

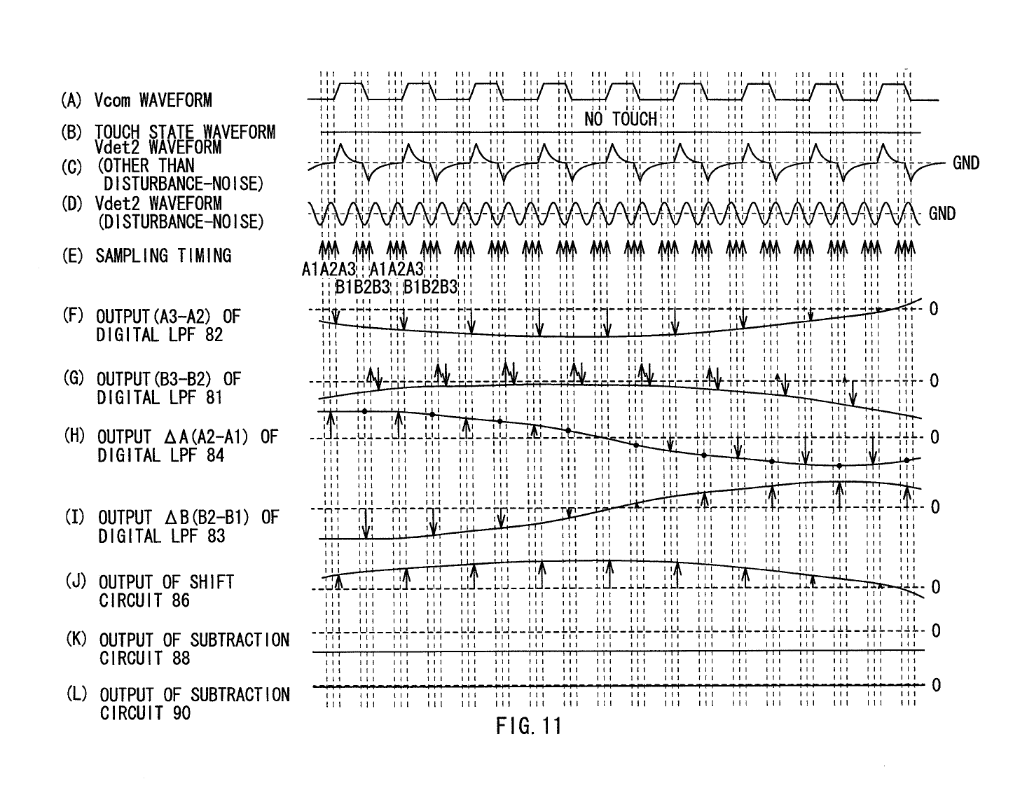

FIG. 11 is a timing chart example of the capacitive touch panel 40 according to the first embodiment of the present invention, and illustrates an example where there is a disturbance-noise at a frequency close to three times the sampling frequency of the A/D conversion section 63.

FIG. 11(A) illustrates a waveform of the drive signal Vcom, (B) illustrates a touch state waveform, (C) illustrates a waveform of the detection signal Vdet2 due to a signal other than the disturbance-noise, and (D) illustrates a waveform of the detection signal Vdet2 due to the disturbance-noise. Here, the detection signal Vdet2 is separately illustrated in FIGS. 11(C) and 11(D), for simplification of description. The actual waveform of the detection signal Vdet2 is a sum of these, and the summed signal is sampled in the A/D conversion section 63. Further, the state where the finger or the like is not in contact with or not in proximity to the touch panel during the whole period is assumed.

FIG. 11(E) illustrates the six sampling timings in the A/D conversion section 63, (F) illustrates an output of the digital LPF 82, and (G) illustrates an output of the digital LPF 81. In FIGS. 11(F) and (G), fluctuation of the waveform caused by the disturbance-noise appears as being obvious in comparison with FIGS. 9(E) and (F). Further, the phase relation between the waveforms of FIGS. 11(F) and (G) is substantially inversed phases to each other. This is caused by that the frequency of the assumed disturbance-noise is close to three times the sampling frequency of the A/D conversion section 63. Further, the touch component is included in the output (G) of the digital LPF 81. Therefore, as will be described later, the phase of the output of the digital LPF 82 is adjusted so that the phase of the output of the digital LPF 81 and the phase of the output of the digital LPF 82 are coincident with each other. And, with the difference between those, it is possible to determine the intended touch detection signal.

FIG. 11(H) illustrates the noise change amount detection signal ΔA as being the output signal of the digital LPF 84, and (I) illustrates the noise change amount detection signal ΔB as being the output signal of the digital LPF 83. When the waveforms of (H) and (I) are compared, the phase relation is substantially inversed phases to each other. This is also caused by that the frequency of the assumed disturbance-noise is close to three times the sampling frequency of the A/D conversion section 63, like the case of (F) and (G). In other words, the phase relation between (F) and (G) is the same as that between (H) and (I). Meanwhile, unlike (F) and (G), (H) and (I) are hardly influenced by the touch component. This means that it is possible to use (H) and (I) when the phase difference between (F) and (G) is detected with high accuracy. Thus, the phase difference detection circuit 87 detects the phase difference between the noise change amount detection signal ΔA (H) and the noise change amount detection signal ΔB (I), and adjusts the phase of the output of the digital LPF 82 based on that result (the multiplication circuit 85 and the shift circuit 86). Since the phase difference between the waveforms of (H) and (I) is substantially inversed phases to each other, the phase difference detection signal Pdet1 is −1, as will be described later. In addition, the phase difference detection signal Pdet2 has a value so that the phase shift amount in the shift circuit 86 is 0 (zero), for convenience of description.

FIG. 11(J) illustrates an output of the shift circuit 86, (K) illustrates an output of the subtraction circuit 88, and (L) illustrates the output Dout of the subtraction circuit 90. With the phase difference detection signals Pdet1 and Pdet2 described above, the output (J) of the shift circuit 86 is an inverse of the output (F) of the digital LPF 82. The output (K) of the subtraction circuit 88 is determined by subtracting the output (J) of the shift circuit 86 from the output (G) of the digital LPF 81. By this subtraction, the fluctuation of the waveform due to the disturbance-noise is canceled. And, the output (L) of the subtraction circuit 90 is determined by subtracting the output of the reference data memory 89 from the output (K) of the subtraction circuit 88 to extract only the touch component. In other words, the output (L) of the subtraction circuit 90 has the waveform similar to the touch state waveform (B).

In addition, although FIG. 11 illustrates the case where the frequency of the disturbance noise is close to three times the sampling frequency of the A/D conversion section 63, without being limited to this case, the situation is also true for the case where the frequency of the disturbance-noise is close to odd number times the sampling frequency. Further, it is also true for the case where the frequency of the disturbance-noise is equal to odd number times the sampling frequency.

(II) Case where there is a Disturbance Noise at a Frequency Close to Even Number Times the Sampling Frequency

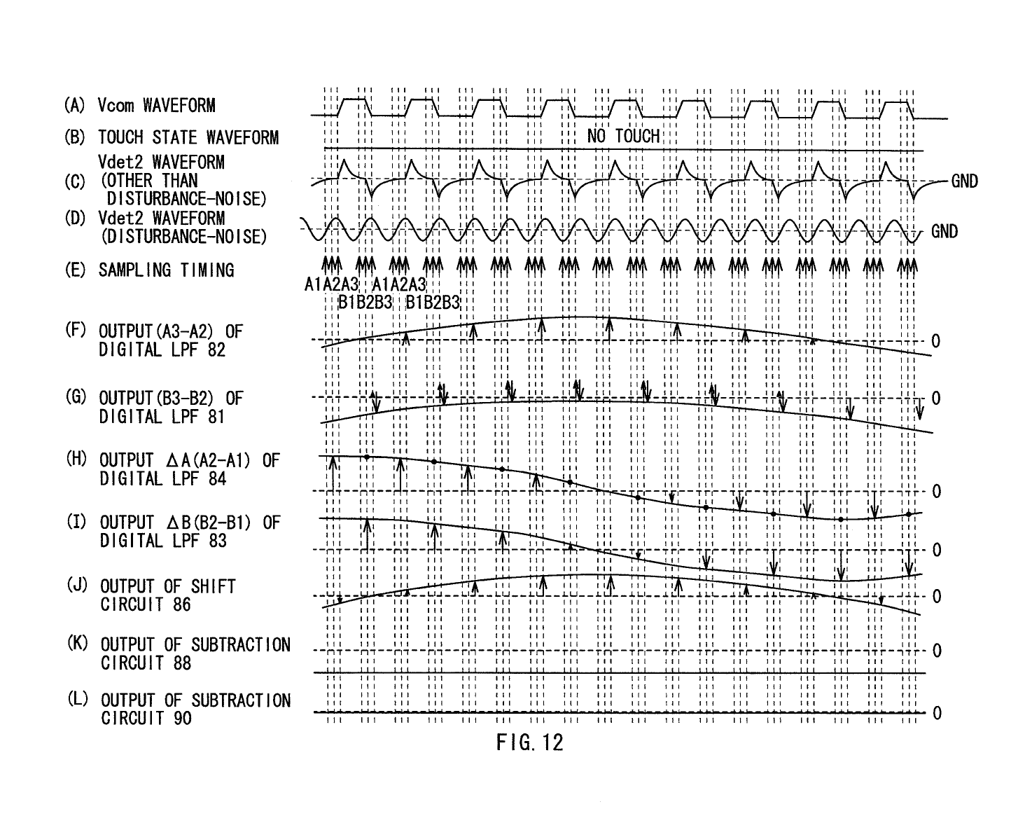

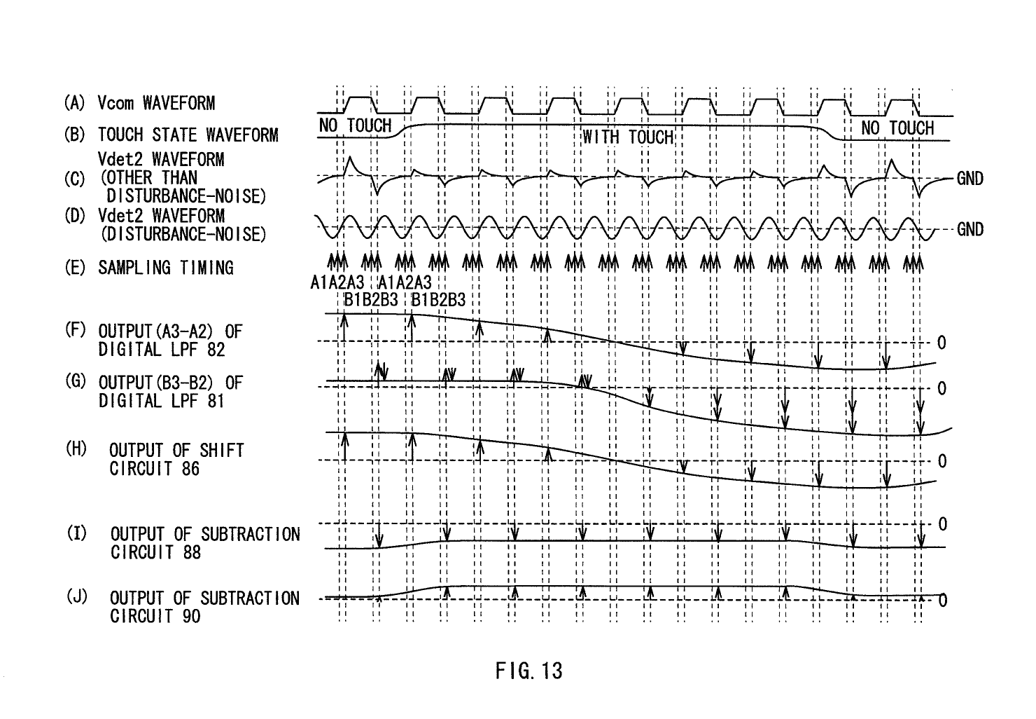

FIG. 12 is a timing chart example of the capacitive touch panel 40 according to the first embodiment of the present invention, and illustrates an example where there is a disturbance-noise at a frequency close to twice the sampling frequency of the A/D conversion section 63.

FIG. 12(A) illustrates a waveform of the drive signal Vcom, (B) illustrates the touch state waveform, (C) illustrates a waveform of the detection signal Vdet2 due to a signal other than the disturbance-noise, and (D) illustrates a waveform of the detection signal Vdet2 due to the disturbance-noise. The conditions are the same as FIG. 12 to simplify the description and make a comparison with FIG. 11 easy.

FIG. 12(E) illustrates the six sampling timings in the A/D conversion section 63, (F) illustrates an output of the digital LPF 82, and (G) illustrates an output of the digital LPF 81. Like FIGS. 11(F) and (G), the fluctuation of the waveform due to the disturbance-noise appears in FIGS. 12(F) and (G). Meanwhile, unlike FIG. 11, the phase relation between FIGS. 12(F) and (G) is substantially in-phase to each other. This is caused by that the frequency of the assumed disturbance-noise is close to twice the sampling frequency of the A/D conversion section 63. Further, information related to the touch signal is included in the output (G) of the digital LPF 81. Therefore, as will be described later, the phase of the output of the digital LPF 82 is adjusted so that the phase of the output of the digital LPF 81 and the phase of the output of the digital LPF 82 are coincident with each other. And, it is possible to determine the intended touch detection signal by the difference between those.

FIG. 12(H) illustrates the noise change amount detection signal ΔA as being the output signal of the digital LPF 84, and (I) illustrates the noise change amount detection signal ΔB as being the output signal of the digital LPF 83. When the waveforms of (H) and (I) are compared, the phase relation is substantially in-phase to each other. This is also caused by that the frequency of the assumed disturbance-noise is close to twice the sampling frequency of the A/D conversion section 63, like the case of (F) and (G). In other words, the phase relation between (F) and (G) is the same as that between (H) and (I). Meanwhile, unlike (F) and (G), (H) and (I) are hardly influenced by the touch component. This means that it is possible to use (H) and (I) when the phase difference between (F) and (G) is detected with high accuracy. Thus, the phase difference detection circuit 87 detects the phase difference between the noise change amount detection signal ΔA (H) and the noise change amount detection signal ΔB (I), and adjusts the phase of the output of the digital LPF 82 based on that result (the multiplication circuit 85 and the shift circuit 86). Since the phase relation between the waveforms of (H) and (I) are substantially in-phase to each other, the phase difference detection signal Pdet1 is +1, as will be described later. In addition, the phase difference detection signal Pdet2 has a value so that the phase shift amount in the shift circuit 86 is 0 (zero), for convenience of description.

FIG. 12(J) illustrates an output of the shift circuit 86, (K) illustrates an output of the subtraction circuit 88, and (L) illustrates the output Dout of the subtraction circuit 90. With the phase difference detection signals Pdet1 and Pdet2 described above, the output (J) of the shift circuit 86 is the same as the output (F) of the digital LPF 82. The output (K) of the subtraction circuit 88 is determined by subtracting the output (J) of the shift circuit 86 from the output (G) of the digital LPF 81. By this subtraction, the fluctuation of the waveform due to the disturbance-noise is canceled. And, the output (L) of the subtraction circuit 90 is determined by subtracting the output of the reference data memory 89 from the output (K) of the subtraction circuit 88 to extract only the touch component. In other words, the output (L) of the subtraction circuit 90 has the waveform similar to the touch state waveform (B).

In addition, although FIG. 12 illustrates the case where the frequency of the disturbance noise is close to twice the sampling frequency of the A/D conversion section 63, without being limited to this case, the situation is also true for the case where the frequency of the disturbance-noise is close to even number times the sampling frequency. Further, it is also true for the case where the frequency of the disturbance-noise is equal to even number times the sampling frequency.

(Operations of the Phase Difference Detection Circuit 87)

Next, operations of the phase difference detection circuit 87 will be described.

In FIG. 8, the phase difference detection circuit 87 performs a two-staged phase difference detection. In a first stage, whether the phase relation between the noise change amount detection signals ΔA and ΔB is the in-phase relation or the inversed phase relation is detected. In a second stage, the phase difference between the noise change amount detection signals ΔA and ΔB is detected in more detail.

The interpolation circuit 91 performs an interpolation process on the time-series data of the noise change amount detection signal ΔA. In FIG. 11, the noise change amount detection signal ΔA (H) is generated in the sampling timing A2. Meanwhile, the noise change amount detection signal ΔB (I) is generated in the sampling timing B2. Thus, a noise change amount detection signal ΔA2 as being the data in the sampling timing B2 is generated by an interpolation process based on the time-series data of the noise change amount detection signal ΔA. The first phase difference detection circuit 94 detects the phase relation between the noise change amount detection signals ΔA and ΔB based on the time-series data of the noise change amount detection signal ΔA2 and the time-series data of the noise change amount detection signal ΔB. As the detection method, for example, a method in which Σ(|ΔA2+ΔB|) and Σ(|ΔA2−ΔB|) are calculated to compare the magnitude relation is possible. In other words, when

Σ(|ΔA2+ΔB|)>Σ(|ΔA2−ΔB|)

is established, the phase relation between the noise change amount detection signals ΔA and ΔB is the in-phase relation to each other. Meanwhile, when

Σ(|ΔA2+ΔB|)<Σ(|ΔA2−ΔB|)

is established, the phase relation between the noise change amount detection signals ΔA and ΔB is the inversed phase relation to each other. The first phase difference detection circuit 94 outputs +1 as the phase difference detection signal Pdet1 in the case where the phase relation between the noise change amount detection signals ΔA and ΔB is the in-phase relation to each other, and outputs −1 as the phase difference detection signal Pdet1 in the case where the phase relation is the inversed phase relation to each other.

The multiplication circuit 92 multiplies the above-described phase difference detection signal Pdet1 and the noise change amount detection signal ΔA. Thereby, its output signal substantially has the in-phase relation with the noise change amount detection signal ΔB. The Fourier interpolation circuit 93 performs, for example, a Fourier interpolation process of 10 points based on the time-series data of the output of the multiplication circuit 92. In addition, a process other than the Fourier interpolation process may be used as the interpolation process. The second phase difference detection circuit 95 detects a more-detailed phase difference based on the time-series data of the noise change amount detection signal ΔB and the time-series data of the output of the Fourier interpolation circuit 93. As the detection method, for example, a method in which the time-series data of the noise change amount detection signal ΔB and the time-series data of the output of the Fourier interpolation circuit 93 are shifted from each other to perform a subtraction process, and an optimal phase shift amount to minimize the subtraction result is determined is possible. The second phase difference detection circuit 95 outputs information related to this phase shift amount as the phase difference detection signal Pdet2.

(Operations when Both the Disturbance-Noise and the Touch Component are Included)

FIG. 13 illustrates an example of timings of the capacitive touch panel 40 according to this embodiment. Here, an example where the detection signal Vdet2 includes the touch component, and the disturbance-noise having a frequency close to twice the sampling frequency of the A/D conversion section 63 is illustrated.

FIG. 13(A) illustrates a waveform of the drive signal Vcom, (B) illustrates a touch state waveform, (C) illustrates a waveform of the detection signal Vdet2 due to a signal other than the disturbance-noise, and (D) illustrates a waveform of the detection signal Vdet2 due to the disturbance-noise. Here, the detection signal Vdet2 is separately illustrated in (C) and (D) for convenience of description. The actual waveform of the detection signal Vdet2 is determined by superimposing these, and this superimposed signal is sampled in the A/D conversion section 63.

FIG. 13(E) illustrates the six sampling timings in the A/D conversion section 63, (F) illustrates an output of the digital LPF 82, and (G) illustrates an output of the digital LPF 81. In (F), the waveform due to the disturbance-noise appears. Meanwhile, in (G), the waveform expressing a sum of the waveform due to the disturbance-noise and the waveform due to the touch signal appears. In (F) and (G), the phase relation between the waveforms due to the disturbance-noise is substantially the in-phase relation to each other. This is caused by that the frequency of the assumed disturbance-noise is close to twice the sampling frequency of the A/D conversion section 63. Therefore, the phase relation between the noise change amount detection signals ΔA (not illustrated in the figure) and ΔB (not illustrated in the figure) is substantially in-phase to each other. Thereby, the phase difference detection signal Pdet1 is +1. In addition, the phase difference detection signal Pdet2 has a value so that the phase shift amount in the shift circuit 86 is 0 (zero).

FIG. 13(H) illustrates an output of the shift circuit 86, (I) illustrates an output of the subtraction circuit 88, and (J) illustrates the output Dout of the subtraction circuit 90. With the phase difference detection signals Pdet1 and Pdet2 described above, the output (H) of the shift circuit 86 is similar to the output (F) of the digital LPF 82. The output (I) of the subtraction circuit 88 is determined by subtracting the output (H) of the shift circuit 86 from the output (G) of the digital LPF 81. By this subtraction, the fluctuation of the waveform due to the disturbance-noise is canceled. And, the output (J) of the subtraction circuit 90 is determined by subtracting the output of the reference data memory 89 from the output (I) of the subtraction circuit 88 to extract only the touch component. In other words, the output waveform (J) of the subtraction circuit 90 is similar to the touch state waveform (B).

(Experimental Example when Both the Disturbance Noise and the Touch Component are Included)

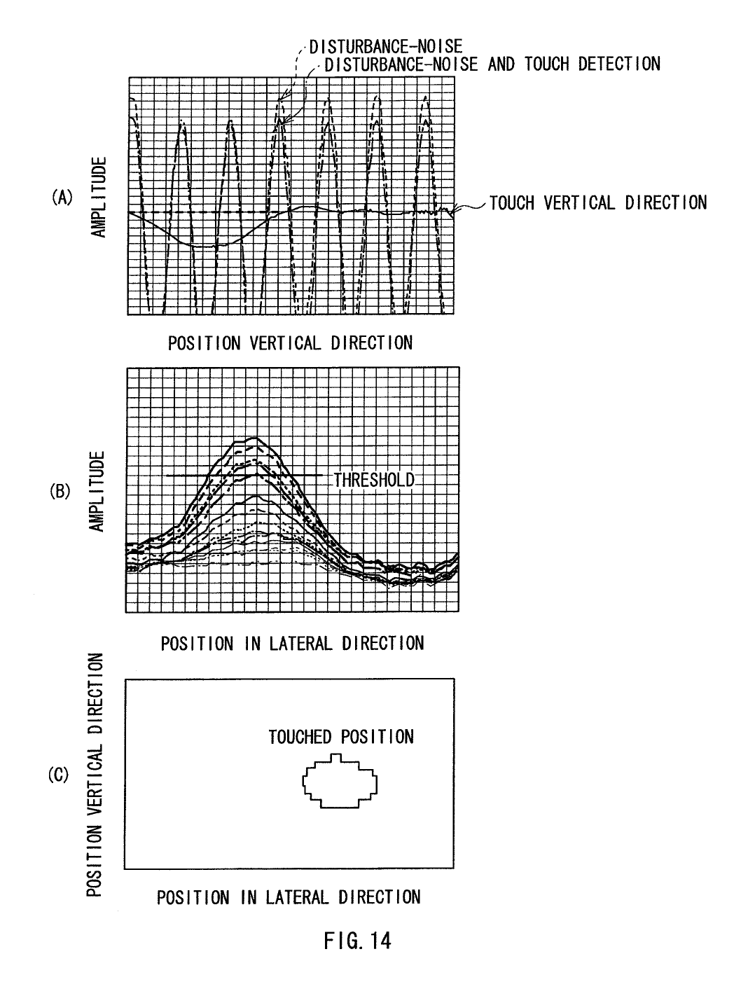

FIG. 14 illustrates an experimental example of operations of the capacitive touch panel 40. (A) illustrates that only the touch component is extracted from the waveform of the disturbance-noise, and the waveform of the disturbance-noise and the touch component. (B) illustrates an example of binarization to a detection signal in the plurality of touch detection electrodes of the touch sensor. (C) illustrates a detection example of a touched position on the touch panel, by the binarization illustrated in (B).

[Effects]

As described above, in this embodiment, when the detection signal Vdet2 is sampled, as illustrated in FIG. 6, all the three sampling timings A1 to A3 in the vicinity of the rise of the drive signal Vcom are set immediately before that rise. Meanwhile, in the three sampling timings in the vicinity of the fall of the drive signal Vcom, B1 and B2 are positioned immediately before the fall of the drive signal Vcom, and B3 is set immediately after the fall. Thus, the sampling outputs in A1 to A3 include the disturbance-noise, and the sampling outputs in B1 to B3 include the touch component and the disturbance-noise component, so it is possible to determine the signal for touch detection by that difference.

Further, it is possible to reduce the disturbance-noise component and limit the frequency band of the signal to be in a low range at the same time by introducing the digital LPF in the subsequent stage of the sampling circuit. Thus, the computation circuit determining the signal for touch detection by calculating the difference is simplified. Accordingly, the circuit structure for the touch detection is reduced in size, and the accuracy of the touch detection is improved.

Further, it is not necessary to sequentially switch the frequency of the drive signal to select the detection conditions like the related art, and it is possible to shorten the detection time.

### Modifications of the First Embodiment

### Modification 1-1

In the above-described embodiment, although the touch component is extracted in the timing in the vicinity of the fall of the drive signal Vcom, instead of this, the touch component may be extracted in the timing in the vicinity of the rise of the drive signal Vcom.

### Modification 1-2

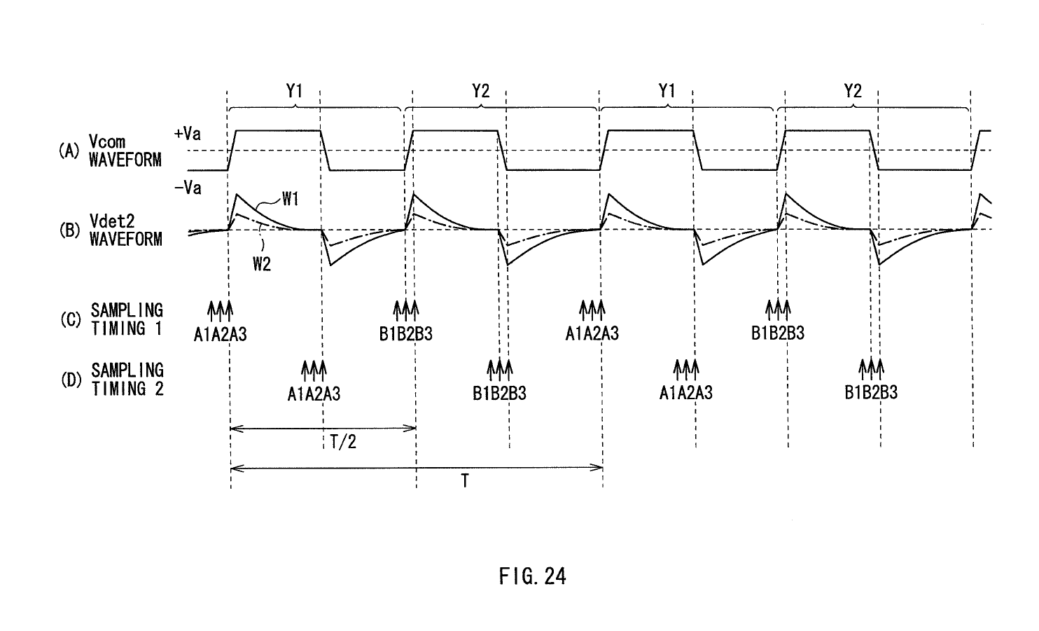

In the above-described embodiment, although the polarity-alternating waveform in which the duty ratio is slightly shifted from 50% is used as the waveform of the drive signal Vcom, it is not limited to this, and instead of this, the waveform including two polarity-alternating waveforms Y1 and Y2 in which the phases are shifted from each other may be used, for example, as illustrated in FIG. 24. In this case, for example, the sampling timing may be like FIG. 24(C), or like FIG. 24(D). In FIG. 24(C), all the three sampling timings A1 to A3 are positioned immediately before the rise of the polarity-alternating waveform Y1. Meanwhile, in the three sampling timings B1 to B3, B1 and B2 exist immediately before the rise of the polarity-alternating waveform Y1, and B3 is positioned immediately after the rise. Further, in FIG. 24(D), all the three sampling timings A1 to A3 are positioned immediately before the fall of the polarity-alternating waveform Y1. Meanwhile, in the three sampling timings B1 to B3, B1 and B2 exist immediately before the fall of the polarity-alternating waveform Y1, and B3 is positioned immediately after the rise. Even with this structure, it is possible to obtain the same effects as the above-described embodiment. Further, since it is possible to make the sampling period longer compared with the case of the above-described embodiment (FIG. 6), it is possible to reduce the current consumption of the A/D conversion section 63 or the like. Further, unlike the case of the above-described embodiment (FIG. 6(A)), in the waveform (FIG. 24(A)) of the drive signal Vcom according to this modification, time spans of different polarities can be equalized in the period with the polarity-alternating waveforms Y1 and Y2. Therefore, the time average value (direct current level) is equal in an odd number frame and an even number frame without changing the duty of the both polarities in one frame, and the drive signal Vcom is easily generated, for example, even in the case where the Vcom generation section 41 supplies the drive signal Vcom to the demultiplexer 42 and the touch sensor 43 by AC drive through the capacitance.

Although the polarity-alternating waveforms Y1 and Y2 each are the polarity-alternating waveform of one period in FIG. 24, it is not limited to this, and, for example, may be a polarity-alternating waveform of two or more periods. Thereby, it is possible to further increase the sampling period, and it is possible to further reduce the current consumption of the A/D conversion section 63 or the like.

### 3. Second Embodiment

Next, the capacitive touch panel according to a second embodiment of the present invention will be described. In addition, same reference numerals will be used for components substantially identical to those of the capacitive touch panel according to the first embodiment.

### Structural Example

### Overall Structural Example

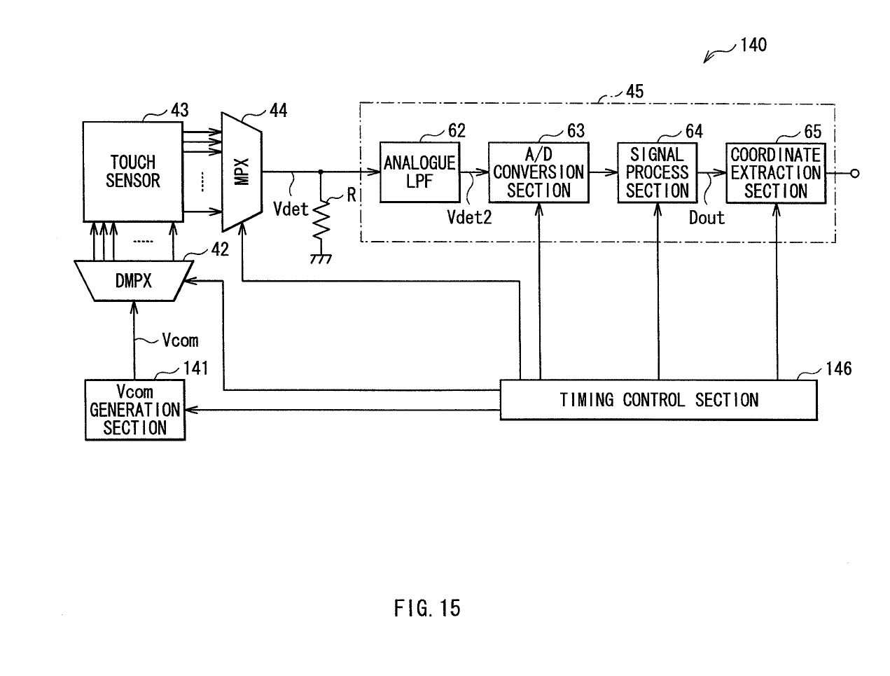

FIG. 15 illustrates a structural example of a capacitive touch panel 140 according to the second embodiment of the present invention. The capacitive touch panel 140 includes a Vcom generation section 141, the demultiplexer 42, the touch sensor 43, the multiplexer 44, the detection section 45, a timing control section 146, and the resistance R.

The Vcom generation section 141 is a circuit generating the drive signal Vcom which drives the touch sensor 43.

The timing control section 146 is a circuit controlling operation timings of the Vcom generation section 141, the demultiplexer 42, the multiplexer 44, and the detection section 45.

In this embodiment, the Vcom generation section 141 and the timing control section 146 are different from those of the first embodiment. Specifically, the waveform generated by the Vcom generation section, and the sampling timing in the A/D conversion section, controlled by the timing control section, are different from those of the first embodiment, respectively.

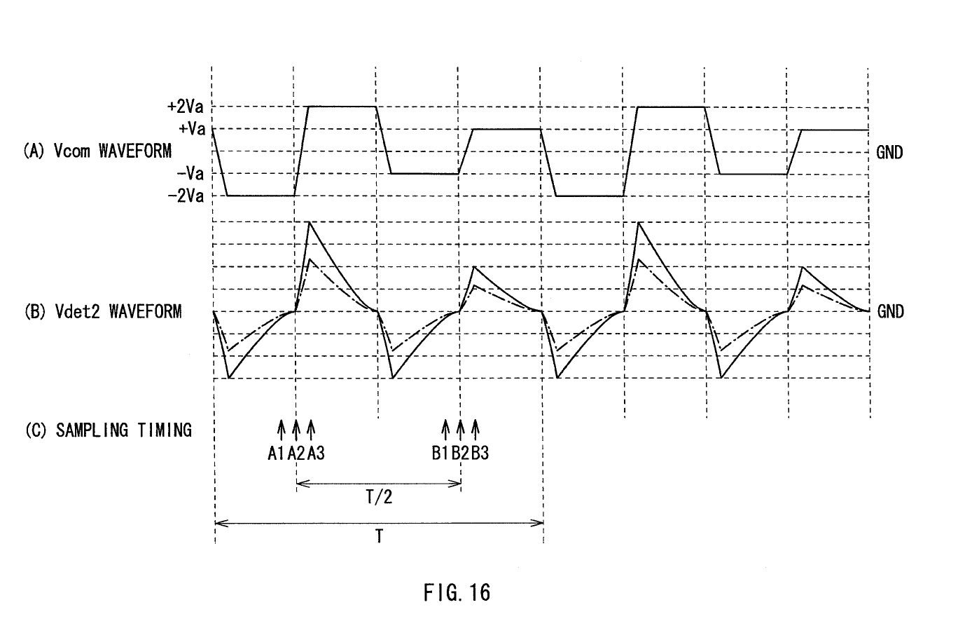

FIG. 16 illustrates a waveform (A) of the drive signal Vcom and a waveform (B) of the detection signal Vdet2, and a sampling timing in the A/D conversion section 63.

The waveform of the drive signal Vcom is a repeated signal with the periods T, in which a section of a first polarity-alternating waveform having a first amplitude, and a section of a second polarity-alternating waveform having a second amplitude different from the first amplitude are alternated. The first polarity-alternating waveform starts from the fall, and its amplitude (the first amplitude) is 2Va. Although the second polarity-alternating waveform also starts from the fall in the same manner, its amplitude (the second amplitude) is Va.

The waveform of the detection signal Vdet2 is a waveform synchronized with the drive signal Vcom, and has an amplitude according to the electrostatic capacitance between the drive electrode 53 and the touch detection electrode 55. In other words, the detection signal Vdet2 has a waveform with a large amplitude in the state where the finger or the like is not in contact with, or not in proximity to the touch panel. Meanwhile, the detection signal Vdet2 has a waveform with a small amplitude in the state where the finger or the like is in contact with or in proximity to the touch panel.

The six sampling timings illustrated in FIG. 16(C) are synchronized with the drive signal Vcom, and their respective sampling frequencies fs are the same as an inverse of the period T of the drive signal Vcom.

These sampling timings exist three by three, adjacent to each other in the vicinity of the rise of the first polarity-alternating waveform and in the vicinity of the rise of the second polarity-alternating waveform of the drive signal Vcom. The three sampling timings A1, A2, and A3 are set in time order in the vicinity of the rise of the first polarity-alternating waveform. Meanwhile, the three sampling timings B1, B2, and B3 are set in time order in the vicinity of the rise of the second polarity-alternating waveform.

The time difference between these sampling timings corresponding to the vicinity of the rise of the first polarity-alternating waveform and the rise of the second polarity-alternating waveform, respectively, is half period T of the drive signal Vcom. In other words, the time difference between the sampling timings A1 and B1, the time difference between the sampling timings A2 and B2, and the time difference between the sampling timings A3 and B3 are T/2, respectively.

In the three sampling timings in the vicinity of the rise of the first polarity-alternating waveform, A1 and A2 are positioned immediately before the rise, while A3 is positioned immediately after the rise. In the same manner, in the three sampling timings in the vicinity of the rise of the second polarity-alternating waveform, B1 and B2 are positioned immediately before the rise, while B3 is positioned immediately after the rise.

Here, the subtraction circuits 77 and 78 are focused. In FIG. 16, the subtraction circuit 77 subtracts a sampled result of the detection signal Vdet2 in the sampling timing B2 from a sampled result of the detection signal Vdet2 in the sampling timing B3, and detects and outputs the change of the detection signal Vdet2 due to the rise of the second polarity-alternating waveform of the drive signal Vcom. Meanwhile, the subtraction circuit 78 subtracts a sampled result of the detection signal Vdet2 in the sampling timing A2 from a sampled result of the detection signal Vdet2 in the sampling timing A3, and detects and outputs the change of the detection signal Vdet2 due to the rise of the first polarity-alternating waveform of the drive signal Vcom. Therefore, the subtraction circuits 77 and 78 output signals having different magnitudes corresponding to the change amount of each rise edge of the first and second polarity-alternating waveforms in the drive signal Vcom. In other words, although the outputs of the subtraction circuits 77 and 78 include the touch component, their signals have different magnitudes. Here, further, the case where the disturbance-noise is included in the detection signal Vdet2 will be considered. In this case, the noise component is included in both the output signals of the subtraction circuits 77 and 78. Therefore, as will be described later, it is possible to remove the disturbance-noise component, and determine the intended touch detection signal by calculating the difference between the output signal of the subtraction circuit 77 and the output signal of the subtraction circuit 78.

Here, a circuit portion constituted of the A/D conversion circuits 74 to 76 which perform samplings in the sampling timings B1 to B3, and the subtraction circuit 77 corresponds to a specific example of “a first sampling circuit” in the present invention. In other words, the output of the subtraction circuit 77 corresponds to a specific example of “a first series of sampling signal including a signal component with first level and a noise component” in the present invention. Meanwhile, a circuit portion constituted of the A/D conversion circuits 71 to 73 which perform samplings in the sampling timings A1 to A3, and the subtraction circuit 78 corresponds to a specific example of “a second sampling circuit” in the present invention. In other words, the output of the subtraction circuit 78 corresponds to a specific example of “a second series of sampling signal including a signal component with second level different from the first level and the noise component” in the present invention.

[Operations and Actions]

(Operations when Both the Disturbance-Noise and the Touch Component are Included)

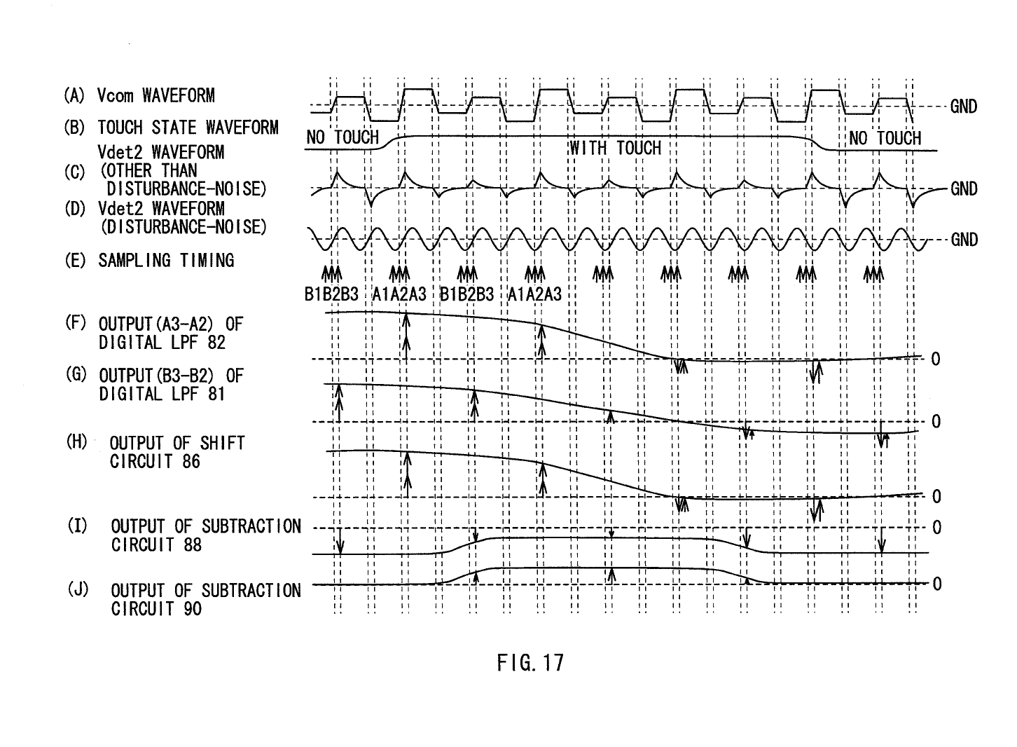

FIG. 17 illustrates an example of timings in the capacitive touch panel 140 according to this embodiment. Here, an example where the detection signal Vdet2 includes the touch component, and the disturbance-noise having a frequency close to four times the sampling frequency of the A/D conversion section 63 is illustrated.

FIG. 17(A) illustrates a waveform of the drive signal Vcom, (B) illustrates a touch state waveform, (C) illustrates a waveform of the detection signal Vdet2 due to a signal other than the disturbance-noise, and (D) illustrates a waveform of the detection signal Vdet2 due to the disturbance-noise. Here, the detection signal Vdet2 is separately illustrated in (C) and (D) for convenience of description. The actual waveform of the detection signal Vdet2 is determined by superimposing these, and this superimposed signal is sampled in the A/D conversion section 63.

FIG. 17(E) illustrates the six sampling timings in the A/D conversion section 63, (F) illustrates an output of the digital LPF 82, and (G) illustrates an output of the digital LPF 81. In both (F) and (G), the waveforms each expressing the sum of the waveform due to the disturbance-noise and the waveform due to the touch signal appear. However, the waveforms due to the touch signal are different from each other in magnitude in (F) and (G). Meanwhile, in the waveforms due to the disturbance noise, the phase relation between (F) and (G) is substantially in-phase to each other. This is caused by that the frequency of the assumed disturbance-noise is close to four times the sampling frequency of the A/D conversion section 63. Therefore, the phase relation between the noise change amount detection signals ΔA (not illustrated in the figure) and ΔB (not illustrated in the figure) is substantially in-phase to each other. Thereby, the phase difference detection signal Pdet1 is +1. In addition, the phase difference detection signal Pdet2 has a value so that the phase shift amount in the shift circuit 86 is 0 (zero), for the convenience of description.

FIG. 17(H) illustrates an output of the shift circuit 86, (I) illustrates an output of the subtraction circuit 88, and (J) illustrates the output Dout of the subtraction circuit 90. With the phase difference detection signals Pdet1 and Pdet2 described above, the output (H) of the shift circuit 86 is similar to the output (F) of the digital LPF 82. The output (I) of the subtraction circuit 88 is determined by subtracting the output (H) of the shift circuit 86 from the output (G) of the digital LPF 81. By this subtraction, the fluctuation of the waveform due to the disturbance-noise is canceled. And, the subtraction circuit 90 subtracts the output of the reference data memory 89 from the output (I) of the subtraction circuit 88 to output the output (J) including only the touch component. In other words, the output (J) of the subtraction circuit 90 has the waveform similar to the touch state waveform (B). In addition, operations of other parts are the same as the first embodiment.

[Effects]

As described above, in this embodiment, when the detection signal Vdet2 is sampled, as illustrated in FIG. 16, in the three sampling timings in the vicinity of the rise of the first polarity-alternating waveform of the drive signal Vcom, A1 and A2 are set immediately before that rise, while A3 is set immediately after the rise. In the same manner, in the three sampling timings in the vicinity of the rise of the second polarity-alternating waveform of the drive signal Vcom, B1 and B2 are set immediately before the rise, while B3 is set immediately after the fall. Thus, the sampling outputs in A1 to A3 include the touch component with a predetermined magnitude and the disturbance-noise component, and the sampling outputs in B1 to B3 include the touch component with a magnitude different from that of the touch component in the sampling outputs in A1 to A3, and the disturbance-noise. Therefore, it is possible to cancel the disturbance-noise component by calculating the difference between those, and it is possible to determine the intended touch detection signal. Other effects are the same as the case of the first embodiment.

### Modifications of the Second Embodiment

### Modification 2-1

In the above-described embodiment, in both the first and second polarity-alternating waveforms in the drive signal Vcom, although the touch component is extracted in the timing in the vicinity of the rise, instead of this, the touch component may be extracted in the timing in the vicinity of the fall of the drive signal Vcom. In this case, in FIG. 16, the drive signal Vcom may have the waveform starting from the rise in both the first and second polarity-alternating waveforms.

### Modification 2-2

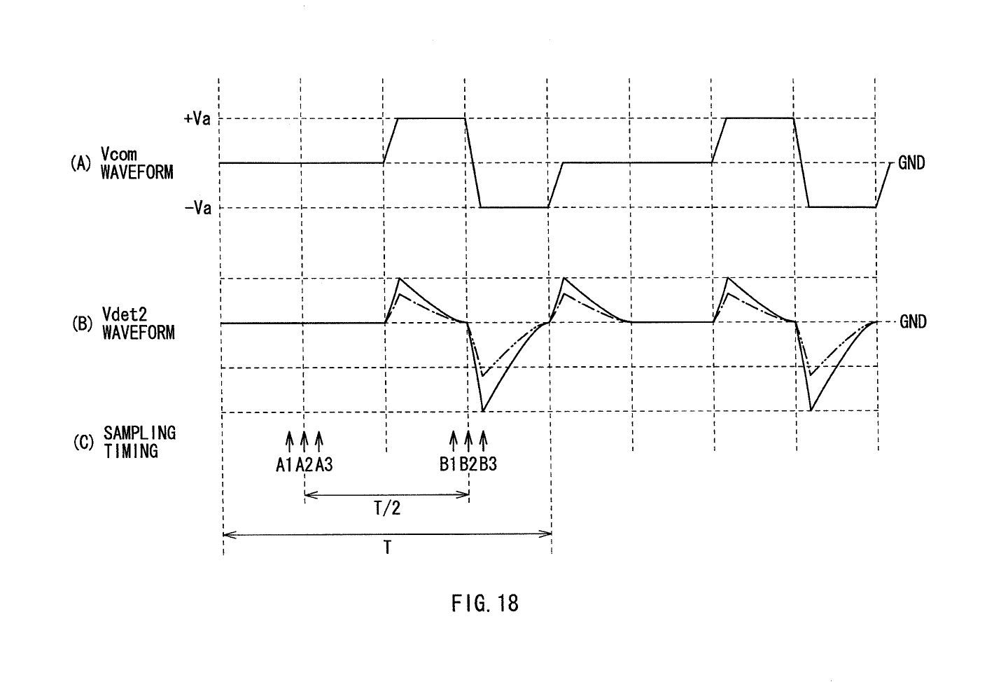

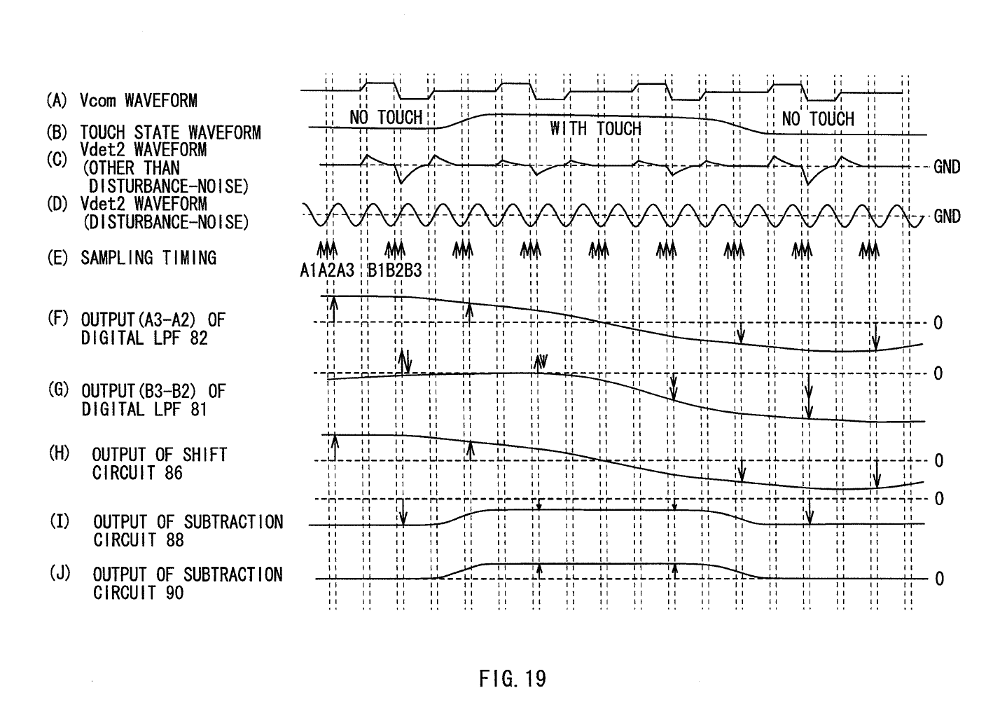

Further, for example, in the above-described embodiment, although the amplitude of the first polarity-alternating waveform of the drive signal Vcom is twice the amplitude of the second polarity-alternating waveform, instead of this, the amplitude of the first polarity-alternating waveform may be set to be any-number times the amplitude of the second polarity-alternating waveform, as long as the multiple number is not 1. In other words, the multiple number may be larger than 1, or smaller than 1. For example, as illustrated in FIGS. 18 and 19, the amplitude of the first polarity-alternating waveform of the drive signal Vcom may be zero times the amplitude of the second polarity-alternating waveform.

### 4. Third Embodiment

Next, a display device with an electrostatic capacitance type touch detection function according to a third embodiment of the present invention will be described. In addition, same reference numerals will be used for components substantially identical to those of the capacitive touch panels according to the first and second embodiments, and description will be omitted.

### Structural Example

### Overall Structural Example

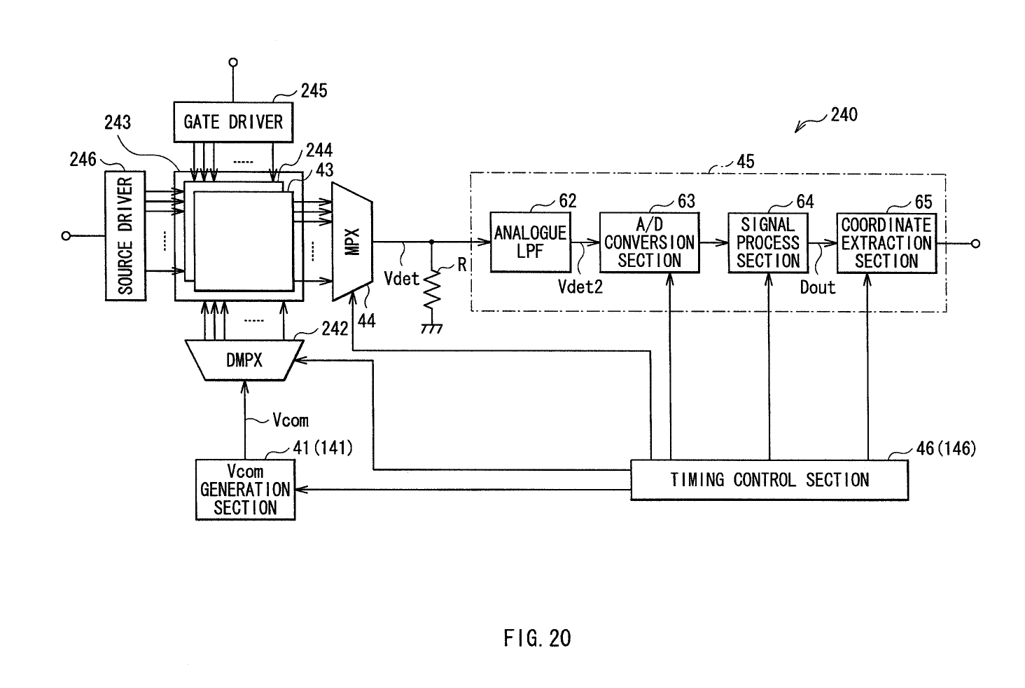

FIG. 20 illustrates a structural example of a display device with an electrostatic capacitance type touch detection function 240 according to the third embodiment of the present invention. The capacitive touch panel 240 includes the Vcom generation section 41 (141), a demultiplexer 242, a display section 243, the multiplexer 44, a detecting section 45, the timing control section 46 (146), and the resistance R. Here, the timing control section 46 is used in the case where the Vcom generation section 41 is used, or the timing control section 146 is used in the case where the Vcom generation section 141 is used.

When the drive signal Vcom supplied from the Vcom generation section 41 or 141 is supplied to the plurality of drive electrodes of the display section 243 one after another, which will be described later, the demultiplexer 42 is a circuit switching its supply destination.

The display section 243 is a device including the touch sensor 43 and a liquid crystal display device 244.

A gate driver 245 is a circuit supplying, to the liquid crystal display device 244, a signal for selecting a horizontal line to be displayed on the liquid crystal display device 244.

A source driver 246 is a circuit supplying an image signal to the liquid crystal display device 244.

(Structural Example of the Display Section 243)

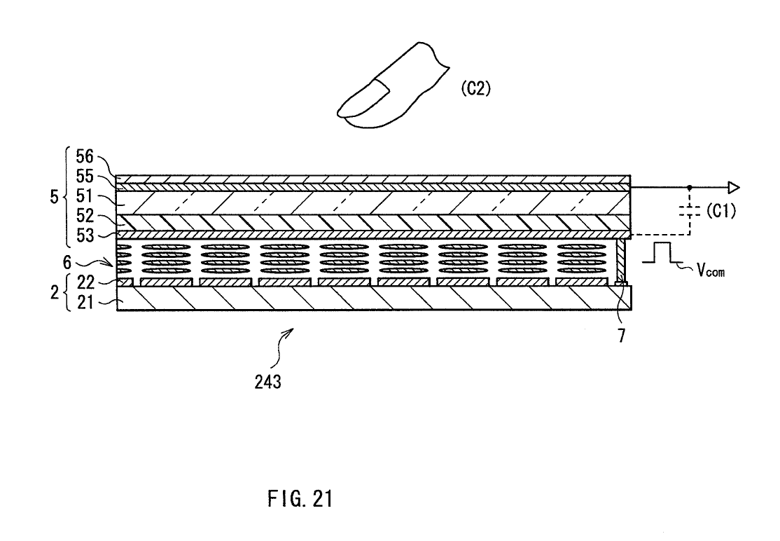

FIG. 21 illustrates an example of the cross-sectional structure of a main part of the display section 243 according to the third embodiment of the present invention. The display section 243 includes a pixel substrate 2, a facing substrate 5 arranged to face the pixel substrate 2, and a liquid crystal layer 6 inserted between the pixel substrate 2 and the facing substrate 5.

The pixel substrate 2 includes a TFT substrate 21 as a circuit substrate, and a plurality of pixel electrodes 22 disposed in matrix on the TFT substrate 21. Although not illustrated in the figure, wirings such as a source line supplying a pixel signal to a TFT (thin film transistor) of each pixel and each pixel electrode, and a gate line driving each TFT are formed on the TFT substrate 21. Also, the TFT substrate 21 may be formed to include a part of, or a whole circuit illustrated in FIG. 20 in addition.

The facing substrate 5 includes a glass substrate 51, a color filter 52 formed on one face of the glass substrate 51, and a drive electrode 53 formed on the color filter 52. The color filter 52 is, for example, configured by periodically aligning color filter layers of three colors of red (R), green (G), and blue (B), and the three colors of R, G, and B correspond to a set in each display pixel. The drive electrode 53 is also commonly used as a drive electrode of the touch sensor 43 performing the touch detection operation, and corresponds to the drive electrode E1 in FIG. 1. The drive electrode 53 is connected to the TFT substrate 21 by a contact conductive column 7. The drive signal Vcom with the alternating rectangular waveform is applied from the TFT substrate 21 to the drive electrode 53 through the contact conductive column 7. The drive signal Vcom defines a pixel voltage applied to the pixel electrode 22 and a display voltage of each pixel, but is also commonly used as a drive signal of the touch sensor. The drive signal Vcom corresponds to the alternating rectangular wave Sg supplied from the drive signal source S of FIG. 1.

The touch detection electrode 55 as being the detection electrode for the touch sensor is formed on the other face of the glass substrate 51, and, further, a polarizing plate 56 is disposed on the touch detection electrode 55. The touch detection electrode 55 constitutes a part of the touch sensor, and corresponds to the detection electrode E2 of FIG. 1.

The liquid crystal layer 6 modulates light passing through the liquid crystal layer 6 according to the state of an electric field, and, for example, a liquid crystal of various modes such as TN (twisted nematic), VA (vertical alignment), and ECB (electrically controlled birefringence) is used.

In addition, although alignment films are disposed between the liquid crystal layer 6 and the pixel substrate 2, and between the liquid crystal layer 6 and the facing substrate 5, respectively, and, further, an incidence side polarizing plate is disposed on the bottom face side of the pixel substrate 2, illustration in the figure is omitted here.

The illustration of FIG. 5 can be used as a structural example of the touch sensor used in the display section illustrated in FIG. 21.

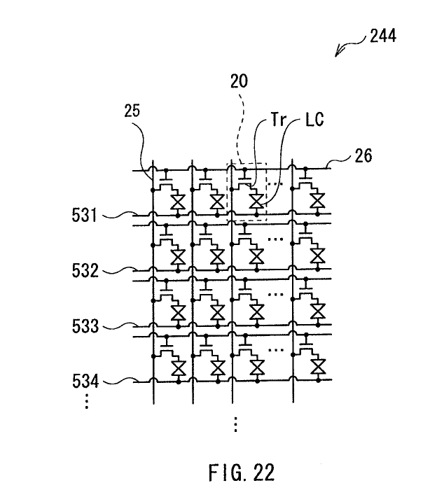

FIG. 22 illustrates a structural example of a pixel structure in the liquid crystal display device 244. A plurality of display pixels 20 each including a TFT element Tr and a liquid crystal element LC are disposed in matrix in the liquid crystal display device 244.

A source line 25, a gate line 26, and the drive electrode 53 (531 to 53n) are connected to the display pixel 20. The source line 25 is a signal line for supplying an image signal to each display pixel 20, and connected to a source driver 46. The gate line 26 is a signal line for supplying a signal for selecting the display pixel 20 which performs a display, and is connected to the gate driver 45. In this example, each gate line 26 is connected to all the horizontally-disposed display pixels 20. In other words, the liquid crystal display device 244 performs a display for each horizontal line by a control signal of each gate line 26. The drive electrode 53 is an electrode applying a drive signal driving a liquid crystal, and is connected to the drive electrode driver 54. In this example, each drive electrode is connected to all the horizontally-disposed display pixels 20. In other words, the liquid crystal display device 244 is driven for each horizontal line by the drive signal of each drive electrode.

[Operations and Actions]

The display device with the touch detection function of this embodiment is a so-called in-cell type touch panel in which the touch sensor in the first and second embodiments is formed together with the liquid crystal display device, and is capable of performing the touch detection as well as a liquid crystal display. In this example, a dielectric layer (the glass substrate 51 and the color filter 52) between the drive electrode 53 and the touch detection electrode 55 contributes to formation of the capacitance C1. Since operations related to the touch detection in this device are exactly the same as those described in the first and second embodiments, description will be omitted, and operations related to the display will be described here.

In the display device with the touch detection function, the pixel signal supplied through the source line 25 is applied to the pixel electrode 22 of the liquid crystal element LC through the TFT element Tr of the display pixel 20 line-sequentially selected by the gate line 26, and the drive signal Vcom in which the polarities are alternated is applied to the drive electrode 53 (531 to 53n). Thereby, pixel data is written into the liquid crystal element LC, and an image is displayed.

In addition, application of the drive signal Vcom to the drive electrode 53 (531 to 53n) may be line-sequentially performed for the individual drive electrodes 531 to 53n in synchronization with the display operation, or may be performed in timings different from those of the display operation. In the latter case, the drive signal Vcom may be line-sequentially applied for a unit of a group constituted of a plurality of drive electrodes.

Further, only the voltage waveform of the drive signal Vcom in the positive section is applied to the drive electrodes 531 to 53n, and the voltage waveform in the negative section may not be applied to the drive electrodes 531 to 53n. Alternatively, the number of the drive electrodes to which the voltage waveform of the drive signal Vcom in the positive section is applied at a given time, and the number of the drive electrodes to which the voltage waveform in the negative section is applied at a given time may be different. In this case, since the waveform of the touch detection signal Vdet is asymmetry in the positive and negative directions, the positive/negative signal waveform in the touch detection signal Vdet is canceled by the analogue low pass filter 62 provided for noise removal, and it is possible to avoid the touch detection from being inhibited.

[Effects]

As described above, in this embodiment, since the touch sensor is integrally formed with the liquid crystal display device to commonly use the common electrode for the display drive and the drive electrode for the touch detection, and to use the common drive signal used in the polarities inversion drive for display also as the drive signal for touch detection, it is possible to realize the display device with the touch detection function with a low-profile simple structure. Other effects are the same as the first and second embodiments.

### Modification of the Third Embodiment

### Modification 3-1

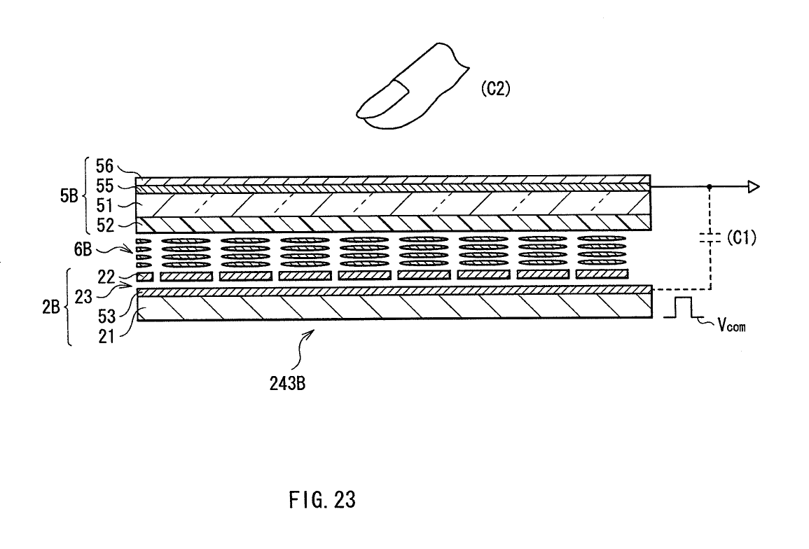

In the above-described embodiment, although the example in which the liquid crystal display device 244 using the liquid crystal of various modes such as TN (twisted nematic), VA (vertical alignment), and ECB (electrically controlled birefringence), and the touch sensor 43 are integrated to constitute the display section has been described, instead of this, a liquid crystal display device using a liquid crystal of lateral electric field modes such as FFS (fringe field switching) and IPS (in-plane switching) and the touch sensor may be integrated. For example, in the case where the liquid crystal of the lateral electric field mode is used, it is possible to constitute a display section 243B as illustrated in FIG. 23. This figure illustrates an example of the cross-sectional structure of a main part of the display section 243B, and illustrates the state where a liquid crystal layer 6B is held between a pixel substrate 2B and a facing substrate 5B. Names, functions, and the like of each of other sections are the same as the case of FIG. 21, and description will be omitted. In this example, unlike the case of FIG. 21, the drive electrode 53 used for both the display and the touch detection is formed immediately above the TFT substrate 21, and constitutes a part of the pixel substrate 2B. The pixel electrode 22 is disposed above the drive electrode 53 through an insulation layer 23. In this case, all the dielectric bodies including the liquid crystal layer 6B, between the drive electrode 53 and the touch detection electrode 55 contributes to formation of the capacitance C1.

### 5. Application Examples

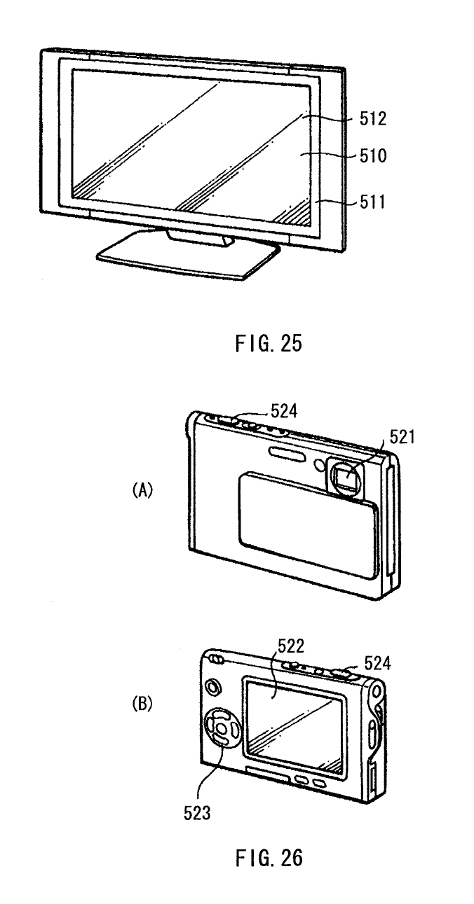

Next, with reference to FIGS. 25 to 29, application examples of the capacitive touch panel, and the display device with the electrostatic capacitance type touch detection function described in the above-described embodiments and modifications will be described. The capacitive touch panel, and the display device with the electrostatic capacitance type touch detection function of the above-described embodiments and the like are applicable to electronic devices in any fields, such as a television device, a digital camera, a notebook personal computer, a portable terminal device such as a mobile phone, and a video camera. In other words, the display device of the above-described embodiments and the like is applicable to electronic devices in various fields for displaying a video signal input from outside or a video signal generated inside as an image or a video.

### First Application Example

FIG. 25 illustrates an appearance of a television device to which the display device with the electrostatic capacitance type touch detection function of the above-described embodiments and the like is applied. The television device has, for example, a video display screen section 510 including a front panel 511 and a filter glass 512. The video display screen section 510 is constituted of the display device with the electrostatic capacitance type touch detection function according to the above-described embodiments and the like.

### Second Application Example

FIG. 26 illustrates an appearance of a digital camera to which the display device with the electrostatic capacitance type touch detection function of the above-described embodiments and the like is applied. The digital camera has, for example, a light emitting section for a flash 512, a display section 522, a menu switch 523, and a shutter button 524. The display section 522 is constituted of the display device with the electrostatic capacitance type touch detection function according to the above-described embodiments and the like

### Third Application Example

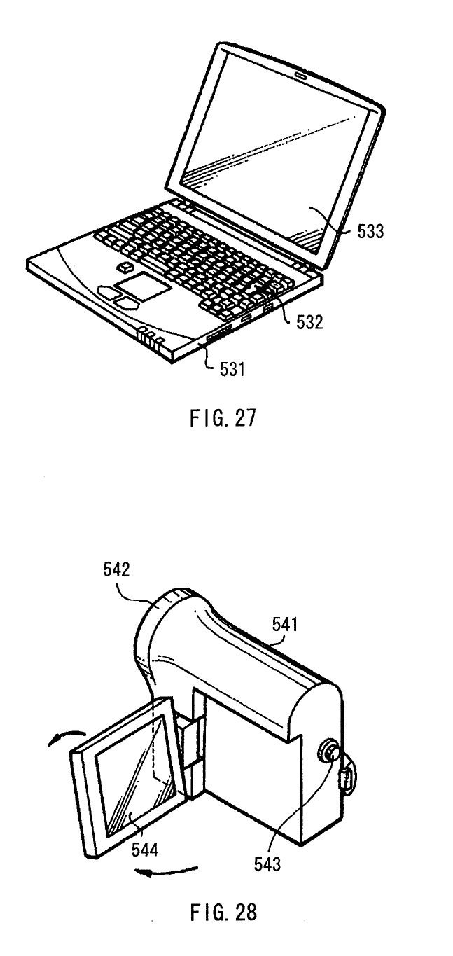

FIG. 27 illustrates an appearance of a notebook personal computer to which the display device with the electrostatic capacitance type touch detection function of the above-described embodiments and the like is applied. The notebook personal computer has, for example, a main body 531, a keyboard 532 for operation of inputting characters and the like, and a display section 533 for displaying an image. The display section 533 is constituted of the display device with the electrostatic capacitance type touch detection function according to the above-described embodiments and the like.

### Fourth Application Example

FIG. 28 illustrates an appearance of a video camera to which the display device with the electrostatic capacitance type touch detection function of the above-described embodiments and the like is applied. The video camera has, for example, a main body 541, a lens 542 for capturing an object provided on the front side face of the main body 541, a start/stop switch in capturing 543, and a display section 544. Also, the display section 544 is constituted of the display device with the electrostatic capacitance type touch detection function according to the above-described embodiments and the like.

### Fifth Application Example

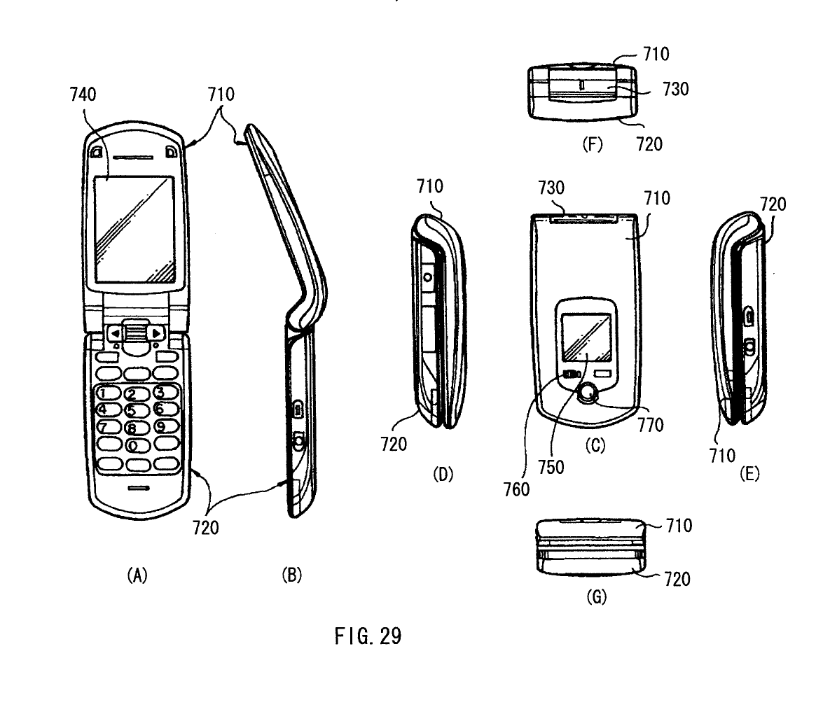

FIG. 29 illustrates an appearance of a mobile phone to which the display device with the electrostatic capacitance type touch detection function of the above-described embodiments and the like is applied. In the mobile phone, for example, an upper package 710 and a lower package 720 are joined by a joint section (hinge section) 730. The mobile phone has a display 740, a sub-display 750, a picture light 760, and a camera 770. The display 740 or the sub-display 750 is constituted of the display device with the electrostatic capacitance type touch detection function according to the above-described embodiments and the like.

Hereinbefore, although the several embodiments and modifications have been described, the present invention is not limited to these, and various modifications are possible. For example, in each of the above-described embodiments, although the drive signal Vcom has the rectangular waveform with the period T in which the polarities are inverted, and its center potential is 0V, instead of this, the center potential may be a potential other than 0V.

1. A capacitive touch panel comprising:
a plurality of drive electrodes each applied with a drive signal for touch detection;
a plurality of touch detection electrodes arranged to intersect the plurality of drive electrodes so that electrostatic capacitance is formed at each of intersections of the drive electrodes and the touch detection electrodes, to output a detection signal synchronized with the drive signal;
a first sampling circuit extracting a first series of sampling signal from the detection signal outputted from each of the touch detection electrodes, the first series of sampling signal including a signal component with first level and a noise component;
a second sampling circuit extracting a second series of sampling signal from the detection signal outputted from each of the touch detection electrodes, the second series of sampling signal including a signal component with second level different from the first level and including a noise component;
a filter circuit performing a high range cut process which allows a band higher than or equal to a predetermined frequency to be cut from the first and second series of sampling signals outputted from the first and second sampling circuits, respectively; and
a computation circuit determining a signal for touch detection based on an output of the filter circuit.

2. The capacitive touch panel according to claim 1, wherein the computation circuit determines the signal for touch detection by finding a difference between the first and second series of sampling signals outputted from the first and second sampling circuit, respectively.

3. The capacitive touch panel according to claim 1, wherein
the drive signal is a signal with a periodic waveform including a section of a first voltage and a section of a second voltage different from the first voltage, and
a scanning control is performed so that the drive signal is applied to each of the plurality of drive electrodes one after another in time-divisional manner.

4. The capacitive touch panel according to claim 1, wherein a sampling period in the first sampling circuit and a sampling period in the second sampling circuit are equal to each other, and a sampling timing in the first sampling circuit is shifted from a sampling timing in the second sampling circuit by half period.

5. The capacitive touch panel according to claim 1, wherein the computation circuit adjusts one or both of a phase of the first series of sampling signal processed by the filter circuit and a phase of the second series of sampling signal processed by the filter circuit so as to allow the phases to coincide with each other, and then determines the signal for touch detection by finding a difference between the two sampling signals.

6. The capacitive touch panel according to claim 1, wherein the second level of the signal component is zero level.

7. The capacitive touch panel according to claim 6, wherein a duty ratio of the drive signal is shifted from 50%.

8. The capacitive touch panel according to claim 6, wherein
the first sampling circuit samples the detection signal at a plurality of timings which are located before and after one voltage change point in the drive signal and are adjacent to one another, and
the second sampling circuit samples the detection signal at a plurality of timings which are located immediately before the other voltage change point in the drive signal and are adjacent to one another.

9. The capacitive touch panel according to claim 1, wherein the drive signal is a signal with a periodic waveform including a section of a first polarity-alternating waveform with a first amplitude and a section of a second polarity-alternating waveform with a second amplitude different from the first amplitude.

10. The capacitive touch panel according to claim 9, wherein
the first sampling circuit samples the detection signal at a plurality of timings which are located before and after a polarity inversion point in the first polarity-alternating waveform and are adjacent to one another, and
the second sampling circuit samples the detection signal at a plurality of timings which are located before and after a polarity inversion point in the second polarity-alternating waveform and are adjacent to one another.

11. The capacitive touch panel according to claim 1, wherein the drive signal is a signal with a periodic waveform including a section of a first polarity-alternating waveform and a section of a second polarity-alternating waveform, the first and second polarity-alternating waveforms having phases shifted from each other.

12. The capacitive touch panel according to claim 11, wherein
the first sampling circuit samples the detection signal at a plurality of timings which are located before and after one of voltage change points in the first polarity-alternating waveform and are adjacent to one another, and
the second sampling circuit samples the detection signal at a plurality of timings which are located immediately before one of voltage change points in the second polarity-alternating waveform and are adjacent to one another.

13. A display device with a touch detection function comprising:
a plurality of drive electrodes each applied with a drive signal for touch detection;
a plurality of touch detection electrodes arranged to intersect the plurality of drive electrodes so that electrostatic capacitance is formed at each of intersections of the drive electrodes and the touch detection electrodes, to output a detection signal synchronized with the drive signal;
a first sampling circuit extracting a first series of sampling signal from the detection signal outputted from each of the touch detection electrodes, the first series of sampling signal including a signal component with first level and a noise component;
a second sampling circuit extracting a second series of sampling signal from the detection signal outputted from each of the touch detection electrodes, the second series of sampling signal including a signal component with second level different from the first level and including a noise component;
a filter circuit performing a high range cut process which allows a band higher than or equal to a predetermined frequency to be cut from the first and second series of sampling signals outputted from the first and second sampling circuits, respectively; and
a computation circuit determining a signal for touch detection based on an output of the filter circuit; and
a display section displaying an image based on an image signal.

14. The display device with the touch detection function according to claim 13, wherein
the display section is configured with a liquid crystal device, and
the drive signal for touch detection also serves as a part of a display drive signal driving the display section.

15. The display device with the touch detection function according to claim 14, wherein
the display drive signal includes a pixel signal based on the image signal and includes a common signal,
the display section performs a display through a polarity-inversion drive in which polarities of a voltage applied to the liquid crystal device are time-divisionally inverted, the voltage being based on the pixel signal and the common signal, and
the drive signal for touch detection also serves as the common signal.
